(19) United States
(12) Patent Application Publication
(10) Pub. No.: US 2015/0378104 A1
(43) Pub. Date: Dec. 31, 2015

(54) COUPLING OPTICAL SYSTEM

(71) Applicant: OLYMPUS CORPORATION, Tokyo (JP)

(72) Inventor: KOICHI TAKAHASHI, Tokyo (JP)

(21) Appl. No.: 14/843,138

(22) Filed: Sep. 2, 2015

Related U.S. Application Data
(63) Continuation of application No. PCT/JP2013/071255, filed on Aug. 6, 2013.

(30) Foreign Application Priority Data
Mar. 7, 2013 (JP) 2013-045148

(51) Int. Cl. G02B 6/28; G02B 6/02; G02B 3/00; G02B 6/34; G02B 6/32; G02B 6/26; G02B 17/06

(52) U.S. Cl. CPC G02B 6/2817; G02B 6/262; G02B 6/02042; G02B 17/0621; G02B 17/0663; G02B 6/34; G02B 6/32; G02B 3/0006

(57) ABSTRACT

An object of the invention is to provide a coupling optical system that uses reflecting surfaces so as to be compatible with even multiple light beams. As shown in FIG. 1, the invention provides a coupling optical system for entering a light beam emitted out of a first optical element in a second optical element, characterized by including at least two reflecting surfaces, wherein:
at least one reflecting surface has a rotationally asymmetric surface shape, and at least two reflecting surfaces are each decentered with respect to an axial principal ray connecting the center of the first optical element with the center of the second optical element.

### BACKGROUND OF THE INVENTION

The present invention relates to a coupling optical system for optical coupling of first and second optical devices.

There has been an optical apparatus so far known in the art for coupling a multicore fiber to multiple single core fibers. For instance, Patent Publication 1 discloses an optical apparatus comprising a first optical system S1 that is positioned on the optical axes of multiple beams emitted out of the multicore fiber so that the optical axes of the respective beams are mutually differentiated in parallel and spaced away from one another and a second optical system S2 adapted to place in a substantially parallel state the optical axes of multiple beams differentiated in parallel on the side of the first optical system S1.

Further, Patent Publication 2 discloses an apparatus having a lens interposed between a multi-core fiber including multiple core areas and two single core fibers to branch off the multicore fiber. The lens used in this apparatus deflects multiple beams emitted out of the multicore fiber in a direction that tilts with respect to the optical axis of the multicore fiber in such a way as to be spaced away from one another.

Patent Publication 3 discloses an optical fiber coupler provided with an optical system for converting the numerical apertures of a multimode fiber and a single mode fiber.

### Patent Publication 1: JP(A) 2013-20227

### Patent Publication 2: JP(A) 60-212710

### Patent Publication 3: JP(A) 11-264918

Patent Publication 1 merely discloses an optical system made telecentric on both sides by the first and second optical systems; it discloses nothing specific about the construction of the telecentric optical system. In other words, that optical system may have been only achieved by use of an existing telecentric optical system. Further, the numerical aperture of each optical device cannot be covered by the first and second optical systems alone, so the second optical system S2 must have one collimator L3 for each single mode fiber. Accordingly, when there are a number of optical paths involved, collimators L3 are needed as many, resulting in an increase in the whole size and cost of the apparatus. In addition, there must be high-precision alignment needed for each collimator L3.

For the apparatus for branching off the multicore fiber, disclosed in Patent Publication 2, there must be the single core fibers tilted and positioned in alignment with that tilt by the lens of the beam from the multicore fiber, resulting in very cumbersome angular adjustment and alignment of the multicore fiber with the single core fibers as well as difficulty with which that apparatus is put to practical use.

The apparatus of Patent Publication 3 is characterized by having an optical system for transformation of the numerical apertures of the multimode fiber and single mode fibers, but there is much difficulty in the simultaneous coupling of multiple fibers.

The apparatus of Patent Publications 1 to 3 use an optical element such as a lens in common. For this reason, there is the need of passing beams through a medium other than air, giving rise to a problem resulting from deteriorations of optical performance and a lowering of coupling efficiency by reason of dispersion and generation of chromatic aberrations upon passage of beams through the optical element.

A main object of the present invention is to provide a coupling optical system that has improved optical performance and higher coupling efficiency.

### SUMMARY OF THE INVENTION

To accomplish the aforesaid object, the present invention provides a coupling optical system for entering a light beam emitted out of a first optical element into a second optical element, characterized by including at least two reflecting surfaces, wherein at least one of said at least two reflecting surfaces has a rotational asymmetric surface shape, and said at least two surfaces are decentered with respect to an axial chief ray connecting the center of said first optical element with the center of said second optical element.

According to the coupling optical system of the invention, light rays emitted out of the first optical element are corrected for decentration aberration by the reflecting surface having a rotationally asymmetric shape before they are coupled on the second optical element. It is thus possible to provide a coupling optical system having improved optical performance and higher coupling efficiency.

### BRIEF DESCRIPTION OF THE DRAWINGS

FIG. 1 is illustrative in construction of the coupling optical system (Example 1) according to one embodiment of the invention.

FIG. 2 is illustrative in construction of the coupling optical system (Example 2) according to another embodiment of the invention.

FIG. 3 is illustrative in construction of the coupling optical system (Example 3) according to yet another embodiment of the invention.

FIG. 4 is illustrative in construction of the coupling optical system (Example 4) according to a further embodiment of the invention.

FIG. 5 is illustrative in construction of the coupling optical system (Example 5) according to a further embodiment of the invention.

FIG. 6 is illustrative in construction of the coupling optical system (Example 6) according to a further embodiment of the invention.

FIG. 7 shows a form of the coupling optical system (Example 5) according to a further embodiment of the invention, wherein optical surfaces are constructed as an optical unit.

FIG. 8 is indicative of a spot diagram for the second optical element in the coupling optical system (Example 1) according to one embodiment of the invention.

FIG. 9 is indicative of a spot diagram for the second optical element in the coupling optical system (Example 2) according to another embodiment of the invention.

FIG. 10 is indicative of a spot diagram for the second optical element in the coupling optical system (Example 3) according to yet another embodiment of the invention.

FIG. 11 is indicative of a spot diagram for the second optical element in the coupling optical system (Example 4) according to a further embodiment of the invention.

FIG. 12 is indicative of a spot diagram for the second optical element in the coupling optical system (Example 5) according to a further embodiment of the invention.

FIG. 13 is indicative of a spot diagram for the second optical element in the coupling optical system (Example 6) according to a further embodiment of the invention.

FIG. 14 is illustrative in construction of the coupling optical system (Example 7) according to a further embodiment of the invention.

FIG. 15 is illustrative in construction of the coupling optical system (Example 8) according to a further embodiment of the invention.

FIG. 16 is illustrative in construction of the coupling optical system (Example 9) according to a further embodiment of the invention.

FIG. 17 is an enlarged view of a microlens array according to one embodiment of the invention.

FIG. 18 is indicative of a spot diagram (at a wavelength of 1600 nm) for the second optical element in the coupling optical system (Example 7) according to a further embodiment of the invention.

FIG. 19 is indicative of a spot diagram (at a wavelength of 1550 nm) for the second optical element in the coupling optical system (Example 7) according to a further embodiment of the invention.

FIG. 20 is indicative of a spot diagram (at a wavelength of 1500 nm) for the second optical element in the coupling optical system (Example 7) according to a further embodiment of the invention.

FIG. 21 is indicative of a spot diagram (at a wavelength of 1600 nm) for the second optical element in the coupling optical system (Example 8) according to a further embodiment of the invention.

FIG. 22 is indicative of a spot diagram (at a wavelength of 1550 nm) for the second optical element in the coupling optical system (Example 8) according to a further embodiment of the invention.

FIG. 23 is indicative of a spot diagram (at a wavelength of 1500 nm) for the second optical element in the coupling optical system (Example 8) according to a further embodiment of the invention.

### DESCRIPTION OF EXEMPLARY EMBODIMENTS

The coupling optical system according to the invention is basically constructed as follows.

The coupling optical system for entering a light beam emitted out of a first optical element into a second optical element is characterized by including at least two reflecting surfaces, wherein at least one of said at least two reflecting surfaces has a rotationally asymmetric surface shape, and said at least two surfaces are decentered with respect to an axial chief ray connecting the center of said first optical element with the center of said second optical element.

By use of the coupling optical system having such construction, light rays emitted out of the first optical element are corrected for decentration aberrations by the reflecting surface having a rotationally asymmetric surface shape before they are coupled on the second optical element. It is thus possible to provide a coupling optical system having improved optical performance and higher coupling efficiency.

Further, the coupling optical system according to the invention may be constructed as follows.

The imaging optical system of the invention is characterized in that multiple light beams emitted out of the first optical element are collectively turned into converged light that is then entered into the second optical element.

The coupling optical system according to the invention comprises reflecting surfaces. When there are multiple light beams coupled together between the first and the second optical element, therefore, there is no need for providing a lens or other optical element for each light beam as experienced in conventional coupling optical systems; so it is possible to use less optical elements than the light beams involved. It is thus possible to reduce the size, weight and cost of the coupling optical system considerably.

Desirously, the imaging optical system should be telecentric on the first and/or the second optical element side.

Referring here to the definition of the term “telecentric”, it is understood to encompass object-side telecentric, image-side telecentric, and both-side telecentric. In the present disclosure, the object side is synonymous with the first optical element side and the image side is synonymous with the second optical element side. In the object-side telecentric arrangement where the entrance pupil is at infinity, all principal rays of multiple light beams (off-axis light rays) emitted out of it typically become parallel with axial principal rays whereas, in the image-side telecentric arrangement where the exit pupil is at infinity, all principal rays of multiple incident light beams again become parallel with axial principal rays. Yet it is difficult to determine whether the off-axial principal rays are parallel with axial principal rays. In the present disclosure, whenever the angle of tilt of a principal ray of off-axis light rays is less than 2 degrees, by definition it will be called telecentric.

Elements capable of emitting out and receiving light beams are presumed as the first and second optical elements. For instance, light sources such as optical fibers and laser diodes and receiving optics such as photodetectors may be used. When multiple elements are lined up for use or a multicore fiber having multiple cores is used, therefore, they are generally lined up in parallel. It is then desired that either one of the first optical element side for taking in light and the second optical element side for receiving light be telecentric. Being telecentric would contribute to higher coupling efficiency because there are substantially vertical principal rays obtained with respect to multiple optical elements.

For the coupling optical system of the invention it is desired that the first optical element side be non-telecentric and the second optical element side be substantially telecentric.

When the second optical element includes multiple input and output ends, for instance when it comprises a bundle of multiple optical fibers or it comprises a multicore fiber having multiple cores, it is preferable that multiple fibers are parallel with one another because they can easily be handled, while the cores of an ordinary multi-core fiber remain parallel with one another. To provide efficient incidence of multiple light beams simultaneously on the coupling optical system, therefore, it is desired that the coupling optical system be telecentric on the second optical element side. On the other hand, the coupling optical system of the invention is designed to be non-telecentric with respect to light beams on the first optical element side, making it easy to locate an aperture stop near an intermediate position of the coupling optical system. Consequently, the angle of tilt of the principal ray emitted out of the first optical element is well balanced against the angle of tilt of the principal ray incident on the second optical element so that the overall optical performance of the coupling optical system can be much more improved.

It is desired that the coupling optical system of the invention be telecentric on both the first and the second optical element side.

As described above, the first and the second optical element are able to emit out and receive light beams. Further, when there are multiple elements lined up for use or when there is a multi-core fiber with multiple cores used, they are typically lined up in parallel. It is then desired that the coupling optical system be telecentric on both the first optical element side for taking in light and the second optical element side for receiving light for the purpose of obtaining higher coupling efficiency. For the purpose of being telecentric on both sides while, at the same time, having higher optical performance, however, there is a high level of aberration correction required, often making the optical system complicated. In the invention, too, four reflecting surfaces are used so as to achieve an optical system telecentric on both sides, as in Examples 3 and 8.

It is desired for the coupling optical system of the invention to satisfy the following condition (1):

TAN≦5° (1)

where TAN (Telecentric Angle of eNtrance) is a difference between the angles of incidence of the principal rays of an off-axis light beam and an axial light beam incident on the second optical element.

When the second optical element includes multiple input/output ends, for instance in the case of a bundle of multiple optical fibers or a multicore fiber having multiple cores, they are preferably in a parallel state because they can be handled more simply, and the cores of an ordinary multicore fiber remains in a parallel state. Therefore, efficient incidence of multiple light beams simultaneously on the coupling optical system results in changes in axial coupling efficiency and off-axis coupling efficiency as the principal ray of an off-axis light beam has an angle with the axial principal ray on the second optical element side.

As the upper limit of condition (1) is exceeded, it gives rise to a large change in the coupling efficiency of axial and off-axis light beams and, hence, a difference between the light intensities of multiple light beams, making the intensity of the off-axis light beam in particular insufficient.

Further in order to hold back changes in the coupling efficiency of multiple input/output ends, it is desired for the coupling optical system of the invention to satisfy the following condition (2):

TAN≦3° (2)

It is desired for the coupling optical system of the invention to satisfy the following condition (3):

TAX≦5° (3)

where TAX (Telecentric Angle of eXit) is a difference between the angles of exit of the principal ray and axial principal ray of an off-axis light beam emitted out of the first optical element.

When the first optical element includes multiple input/output ends, for instance in the case of a bundle of multiple optical fibers or a multicore fiber including multiple cores, they are preferably in a parallel state because they can be handled more simply, and the cores of an ordinary multicore fiber remains in a parallel state. Therefore, efficient incidence of multiple light beams simultaneously on the coupling optical system results in changes in axial coupling efficiency and off-axis coupling efficiency as the principal ray of an off-axis light beam has an angle with the axial principal ray on the first optical element side.

As the upper limit of condition (3) is exceeded, it gives rise to a large change in the coupling efficiency of axial and off-axis light beams and, hence, a difference between the light intensities of multiple light beams, making the intensity of the off-axis light beam in particular insufficient.

Further in order to hold back changes in the coupling efficiency of multiple input/output ends, it is desired for the coupling optical system of the invention to satisfy the following condition (4):

TAX≦3° (4)

Further in the coupling optical system of the invention, the aforesaid at least two reflecting surfaces are desirously reflecting mirrors.

Adoption of the coupling optical system of such construction ensures that light rays emitted out of the first optical element are coupled on the second optical element through the optical action of the reflecting surfaces alone. An optical path taken by these light rays do not pass through a medium other than air to prevent dispersion and generation of chromatic aberrations in the coupling optical system.

It is thus possible to couple all electromagnetic waves including light in the band where there is the reflectivity of at least two reflecting surfaces. For instance with a surface reflecting mirror comprising glass coated with gold, it is possible to couple even electromagnetic waves in the wave region inclusive of visible light, infrared light, THz waves and microwaves. When the coupling optical system of the invention is used for optical communication, the same performance is achievable in every wavelength even at the time of using light having multiple wavelengths by way of wavelength multiplexing technology.

For the coupling optical system of the invention, it is desired that at least two of the aforesaid reflecting surfaces include between them a decentered prism filled with a medium having a reflectivity of at least 1.

Use of the decentered prism ensures that a reflecting surface having power has internal reflection. And the power of the reflecting surface is multiplied by the reflectance of the medium with the consequence that the radius of curvature of the reflecting surface grows large (or the curvature gets small), resulting in reductions of aberrations occurring at the reflecting surfaces and improvements in the performance of the whole optical system. The provision of the decentered prism also ensures that at least two reflecting surfaces that the decentered prism includes can be so positioned and located that reductions in the steps involved for assemblage and adjustment of the coupling optical system are achievable at lower costs.

When there are the first and the second reflecting surfaces as counted in order from the first optical element side, it is desired that the aperture stop of the coupling optical system be positioned between the first and the second reflecting surface.

The role of the first reflecting surface is to make use of its positive power to reduce the spreading of a light beam emitted out of the first optical element so that the light beam can be converged at the second reflecting surface for converging and coupling to the second optical element. Here if the aperture stop is interposed between the first and the second reflecting surface, there is then an apparently two-side telecentric optical system obtained so that the angle of tilt of the principal ray either on the first or the second optical element side can be kept small.

Desirously, both the aforesaid at least two reflecting surfaces have a positive power.

As described above, the role of the first reflecting surface is to make use of its positive power to reduce the spreading of a light beam emitted out of the first optical element so that the light beam can be converged at the second reflecting surface for converging and coupling to the second optical element. To this end, both the reflecting surfaces should have a positive power. Allowing at least two reflecting surfaces to have a positive power ensures that the power of the whole optical system is dispersed contributing to reductions of ray aberrations occurring at the respective surfaces.

The coupling optical system of the invention is characterized by comprising at least four reflecting surfaces: a first reflecting surface, a second reflecting surface, a third reflecting surface and a fourth reflecting surface as counted in order from the first optical element side, wherein a pupil is formed between the second and the third reflecting surface.

A front group of the coupling optical system is defined by the first and the second reflecting surface with a pupil formed near the back focal position of the front group, and the pupil is brought in alignment with the back focal position of a rear group defined by the third and the fourth reflecting surface, making the coupling optical system telecentric on both its sides (see Example 3).

Where both the first and the second optical element include multiple parallel inputs and outputs, being telecentric on both sides makes sure higher coupling efficiency.

The coupling optical system of the invention should preferably satisfy the following condition (5):

AOI≦45° (5)

where AOI is the angle of incidence of the first reflecting surface.

Condition (5) is provided to define the angle of reflection on the first reflecting surface necessary for reducing the amount of decentration aberration occurring at the first reflecting surface. As the upper limit of 45° is exceeded, it causes the angle of reflection off the first reflecting surface to grow large; decentration aberration occurring at the first reflecting surface grows too much to correct them at other reflecting surface(s).

The coupling optical system of the invention should desirously satisfy the following condition (6):

−30°≦ABM≦60° (6)

where ABM (Angle of Mirror) is the angle made between the first and the second reflecting surface in the Y-Z plane with the proviso that the first and the second reflecting surface have an amount of decentration in the same plane.

ABM provides a definition of the angle of the second reflecting surface with respect to the first reflecting surface assuming that the CCW (counterclockwise) direction is taken as positive. This condition is provided to limit the orientation of the second reflecting surface relative to the first reflecting surface: it is provided to limit the direction of reflection off the second reflecting surface for proper determination of the angle of reflection off the second reflecting surface.

As the lower limit of −30° is not reached, it causes the angle of incidence of rays on the second reflecting surface to grow large. In turn, this causes the orientation of rays after reflected off the second reflecting surface to space away from the principal ray emitted out of the first optical element, resulting in an increase in the size of the apparatus involved. As the upper limit of 60° is exceeded, it causes the angle of reflection off the second reflecting surface to grow large. In turn, this causes the second reflecting surface to have a larger area, again resulting in an increase in the size of the apparatus involved.

There are at least four reflecting surfaces provided: the first, the second, the third, and the fourth reflecting surface as counted in order from the first optical element side. Here if an intermediate image is formed between the second and the third reflecting surface, it is then effective for coupling at higher magnifications.

Rays emitted out of the first optical element are imaged as an intermediate image by the first and the second reflecting surface, and that intermediate image is relayed to the second optical element by way of the third and the fourth reflecting surface (see Examples 4 and 5). This allows imaging to occur twice, making the setting of magnifications easier and making magnifications higher. This also enables to make the combined focal lengths between the first and the second reflecting surface and between the third and the fourth reflecting surface so shorter that the powers of the respective optical surfaces can increase. Consequently, there are larger numerical apertures effectively obtained.

The coupling optical system of the invention will now be explained with reference to Examples 1 to 9. Note that constituting parameters (numerical examples) for the respective examples will be given later.

### Example 1

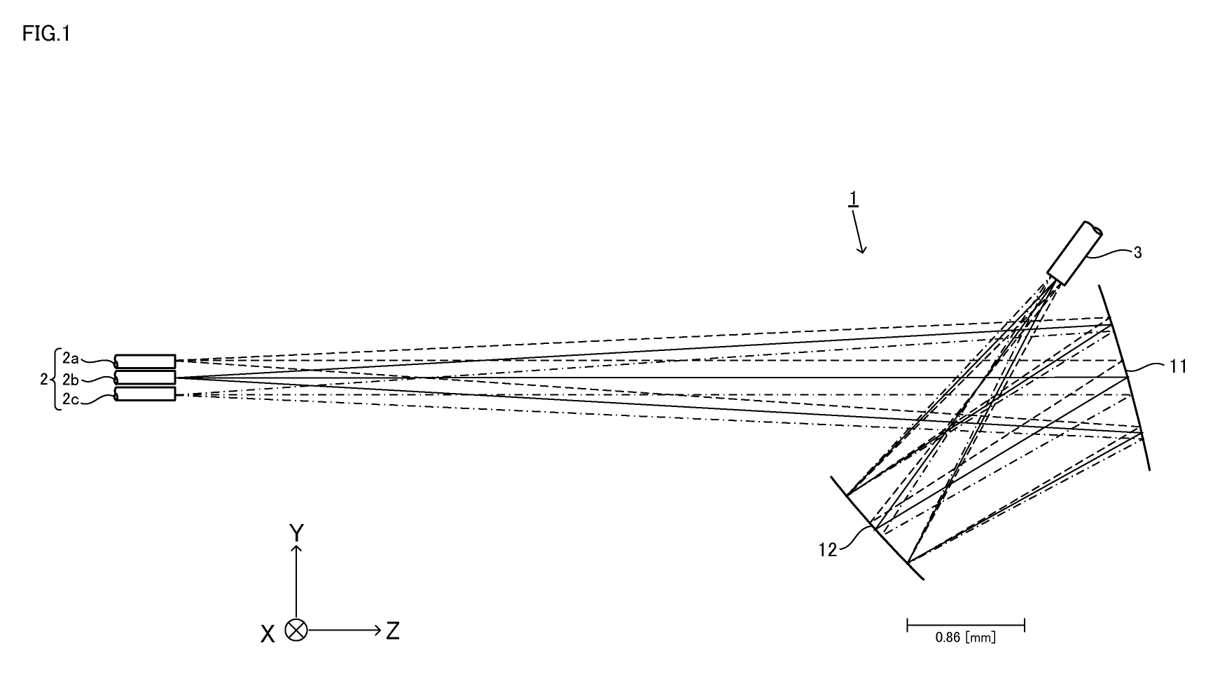

First of all, the coordinate system, decentered surface and free-form surface used in Examples 1 to 6 are explained. As shown in FIG. 1, an axial principal ray in each example is defined by a ray coming out of the center of a single core fiber 2b working as a unit optical element in a first optical element 2 and then reflected off the respective reflecting surfaces, eventually arriving at the center of a second optical element 3 (multicore fiber), and the origin of the coordinate system is defined by the center of the single core fiber 2a positioned at the center within the first optical element 2. The Z-axis positive direction is defined by a direction propagating along that axial principal ray, the Y-Z plane is defined by a plane including the Z-axis and the center of the image plane, the X-axis positive direction is defined by a direction orthogonal to the Y-Z plane through the origin and going from the front surface of the sheet down to the back surface, and the Y-axis is defined by an axis that forms with the X- and Z-axes a right-handed orthogonal coordinate system.

FIG. 1 is illustrative in construction of the coupling optical system according to one embodiment of the invention (Example 1). The coupling optical system 1 according to this embodiment is designed such that light beams having mutually parallel optical axes, emitted out of the first optical element 2 comprising a bundle of six single fibers (only three 2a, 2b and 2c of which are shown in FIG. 1 that is a Y-Z sectional view; the same will hold throughout the examples described later) are entered into the multicore fiber 3 (second optical element 3). On the multicore fiber 3 side, light beams emitted out of the single fibers 2a-2c are incident for each core. In other words, multiple light beams emitted out of the first optical element 2 are incident on the second optical element 3 while they are mutually separated.

Although the coupling optical system takes a form of a telecentric optical arrangement on the first optical element 2 side, the angle of tilt of the principal ray on the second optical element 3 side has a relative large value because of a stop position located between the second reflecting surface 12 and the second optical element 3.

It is here to be noted that the single core fibers 2a-2c and multicore fiber 3 may be reversed in terms of input and output. One possible modification of the first optical element 2 that emits out light having mutually parallel optical axes may include an assembly comprising multiple laser diodes (LDs) lined up on an array or the like.

The coupling optical system 1 of Example 1 comprises two reflecting surfaces 11 and 12. Light beams emitted out of the cores of the single core fibers 2a-2c are first reflected off the first reflecting surface 11, and then reflected off the second reflecting surface 12 for coupling on the second optical element 3.

Light beams emitted out of multiple single core fibers 2a-2c forming the first optical element 2 are reflected off the first reflecting surface 11 decentered with respect to the axial principal ray. Then, the light beams are again reflected off the second reflecting surface 12 decentered with respect to the axial principal ray for coupling at the respective core positions of the multicore fiber 3 operating as the second optical element 3. Such construction of the coupling optical system 1 enables the respective light beams emitted out of the single core fibers 2a-2c to be incident on the respective cores of the multicore fiber 3 so that they can be optically coupled together between the first 2 and the second optical element 3.

Preferably, either one of the at least two reflecting surfaces: the first 11 and the second reflecting surface 12 should have a rotationally asymmetric curved surface shape because the coupling optical system can effectively be corrected for decentration aberration resulting from decentration of the first 11 and the second reflecting surface 12 with respect to the axial principal ray.

Decentration aberration is a complicated one different from Seidel aberrations occurring in a co-axial optical system. There is much difficulty in correction of such aberration asymmetric with respect to the optical axis using a spherical surface or other surface having an axis of rotation. This is the reason why either one of the first 11 and the second reflecting surface 12 has preferably a rotational asymmetric curved surface shape for correction of aberration. Further, if positive power is given to the first 11, and the second reflecting surface 12, it is then possible to reduce aberrations occurring at the respective surfaces because the power of the whole optical system can be dispersed.

### Example 2

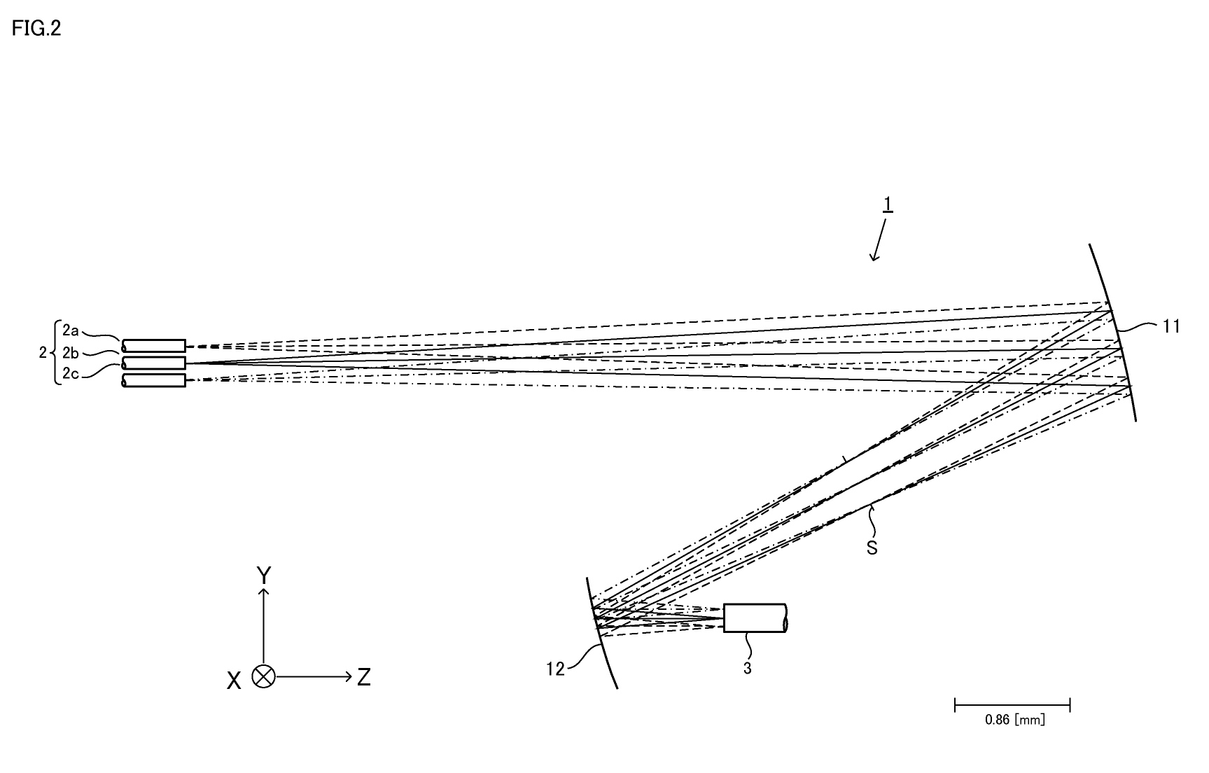

FIG. 2 is illustrative in construction of another embodiment of the coupling optical system (Example 2). This example is common to Example 1 in that single core fibers 2a-2c are used for the first optical element 2 that emits out light beams and a multicore fiber 3 is used for the second optical element 3.

The coupling optical system 1 of Example 2 comprises two reflecting surfaces 11 and 12. Light beams emitted out of the cores of the respective single core fibers 2a-2c are reflected off the first reflecting surface 11, and then reflected off the second reflecting surface 12 for coupling at the respective core positions of the multicore fiber 3 (third optical element 3). Such construction of the coupling optical system 1 enables the respective light beams emitted out of the single core fibers 2a-2c to be incident on the respective cores of the multicore fiber 3 so that they can be optically coupled together between the first 2 and the second optical element 3.

An aperture stop position S is located between the first 11 and the second reflecting surface 12. Thus, although the coupling optical system of this example forms a non-telecentric optical arrangement on the first optical element 2 side, yet the angle of tilt of the principal ray on both the first 2 and the second optical element 3 side has a relatively small value because the aperture stop position S remains near the center of the coupling optical system.

Further, Example 2 is different from Example 1 in that the output direction of the first optical element 2 and the input direction of the second optical element 3 tilt in Example 1 whereas they are in a substantially linear direction in Example 2. Such construction of Example 2 ensures that the single core fibers 2a-2c used for output and the multicore fiber 3 used for input are kept in a substantially linear relationship. On a millimeter scale, the size of the coupling optical system 1 is as extremely small as a few millimeters so that even when it is located between the single core fibers 2a-2c and the multicore fiber 3, it may be handled as a substantially linear fiber, resulting in facility in handling.

### Example 3

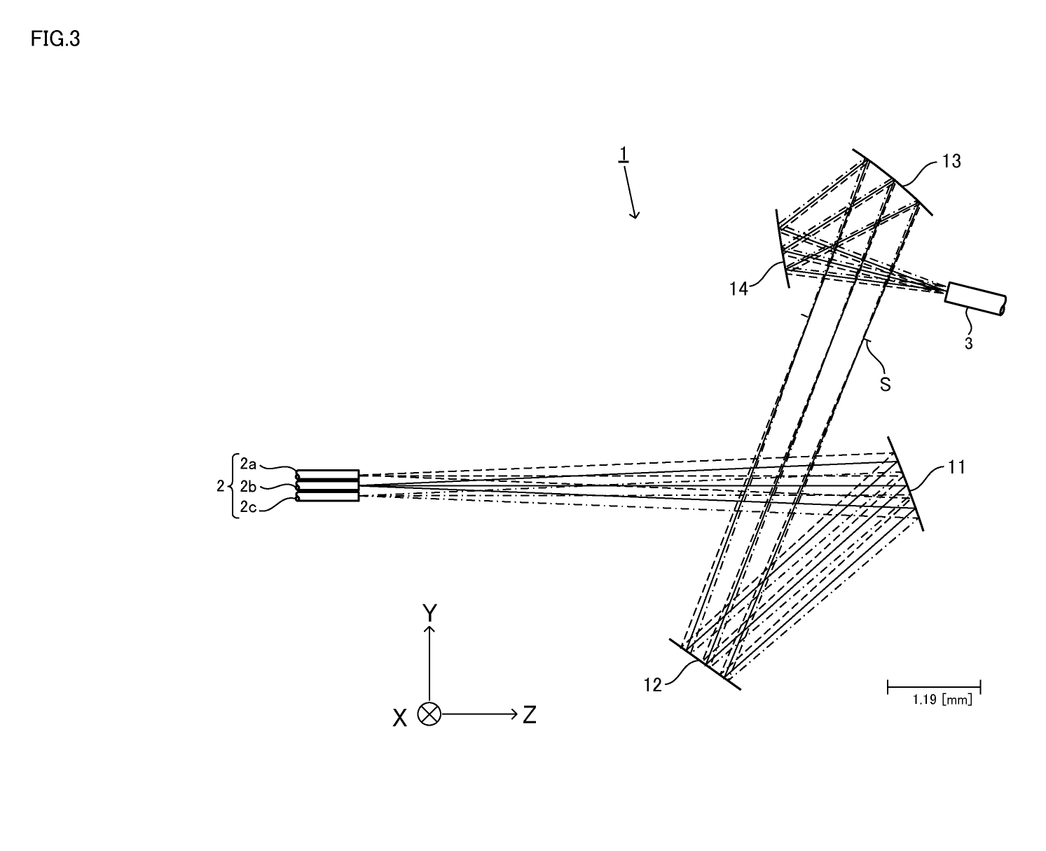

FIG. 3 is illustrative in construction of yet another embodiment of the coupling optical system (Example 3). The coupling optical system 1 of Example 3 is different from the aforesaid examples in that four reflecting surfaces 11, 12, 13 and 14 are used. However, Example 3 is common to the aforesaid examples in that single core fibers 2a-2c are used for the first optical element 2 that emits out light beams and a multicore fiber 3 is used for the second optical element 3.

The coupling optical system 1 of Example 3 comprises four reflecting surfaces 11 to 14. The respective light beams emitted out of the respective single core fibers 2a-2c are reflected off the first 11, the second 12, the third 13 and the fourth reflecting surface 14 in this order for coupling at the respective core positions of the multicore fiber 3 (second optical element 3). Such construction of the coupling optical system 1 ensures that the respective light beams emitted out of the single core fibers 2a-2c are incident on the respective cores of the multicore fiber 3 so much so that they can be optically coupled together between the first 2 and the second optical element 3.

Example 3 is characterized in that there is a pupil formed between the second 12 and the third reflecting surface 13. A front group of the coupling optical system 1 is defined by the first 11 and the second reflecting surface 12, and the pupil is formed near the back focal position of the front group and in alignment with the front focal position of a rear group defined by the third 13 and the fourth reflecting surface 14. Such coupling optical system 1 is telecentric on both the first 12 and the second optical element 3.

When multiple light beams are put in, or put out of, the second optical element 3, for instance in the case of a multicore fiber including multiple cores such as the one used in the examples herein or a bundle of multiple single core fibers, they are preferably placed in a parallel state because of facility in handling. The respective cores of an ordinary multicore fiber remain placed in parallel, so are the optical axes (principal rays) emitted out of them. To simultaneously and efficiently take the multiple light beams emitted out of the first optical element 2 in the coupling optical system or to improve coupling efficiency, therefore, it is desired that the coupling optical system be telecentric on the second optical element 3 side.

In a mode or the like of bidirectional communications between the first 2 and the second optical element 3, the second optical element 3 is positioned on the output side and the first optical element 2 is positioned on the input side. It is then preferable that the coupling optical system is telecentric on the first optical element 2 side, too, for the same reason as described above.

### Example 4

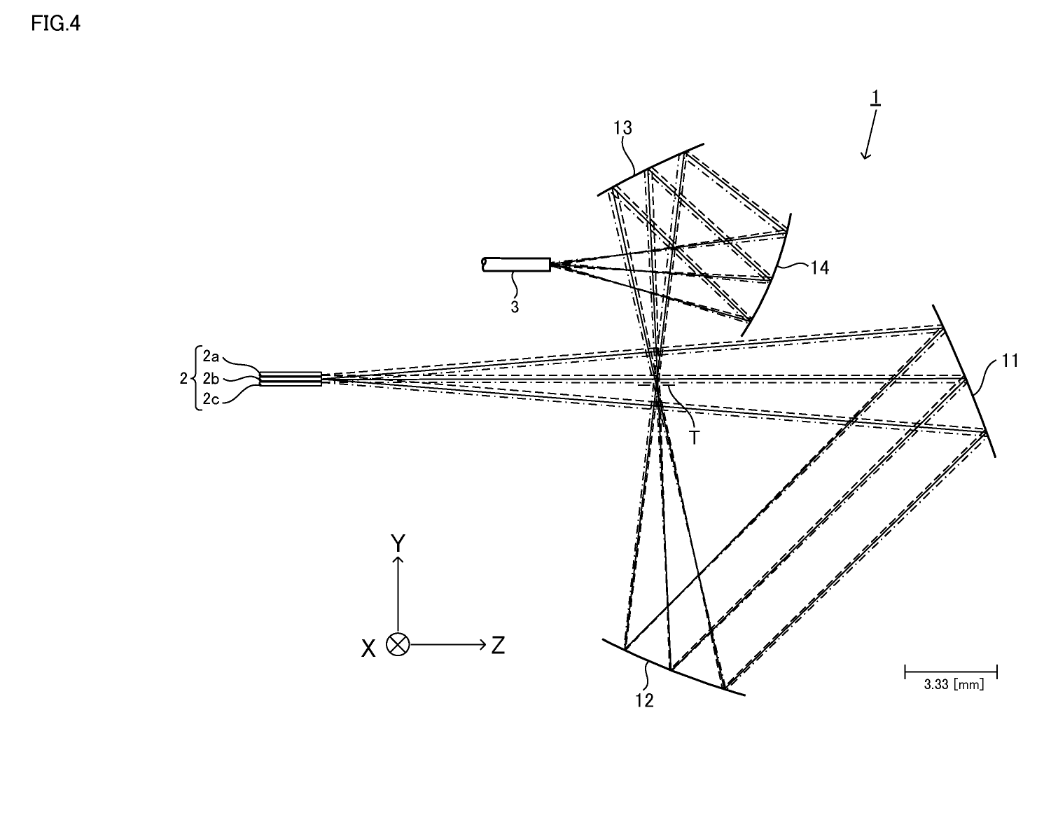

FIG. 4 is illustrative in construction of a further embodiment of the coupling optical system (Example 4). The coupling optical system of Example 4 is common to that of Example 3 in that four reflecting surfaces 11 to 14 are used, and also common to those of the aforesaid examples in that single core fibers 2a-2c are used for the first optical element 2 that emits out light beams and a multi-core fiber 3 is used for the second optical element 3.

The coupling optical system 1 of Example 4 comprises four reflecting surfaces 11 to 14. The respective light beams emitted out of the respective cores of single core fibers 2a-2c are reflected off the first 11, the second 12, the third 13 and the fourth reflecting surface 14 in this order for coupling at the respective core positions of a multicore fiber 3 (second optical element 3). Such construction of the coupling optical system 1 ensures that the respective light beams emitted out of the single core fibers 2a-2c are incident on the respective cores of the multicore fiber 3 so much so that they can be optically coupled together between the first 2 and the second optical element 3.

In Example 4, the coupling optical system is telecentric on both the first and the second optical element side, with an intermediate image formed between the second 12 and the third reflecting surface 13. In turn, that intermediate image is coupled on the second optical element. Such two imaging cycles make magnification control easier.

The coupling optical system of Example 4 is on the assumption that the single core fibers forming the first optical element 2 have a large numerical aperture. This example is effective for a typical case where coupling takes place between the first optical element comprising a fiber having a large numerical aperture such as a multimode fiber and the second optical element comprising a multicore fiber.

### Example 5

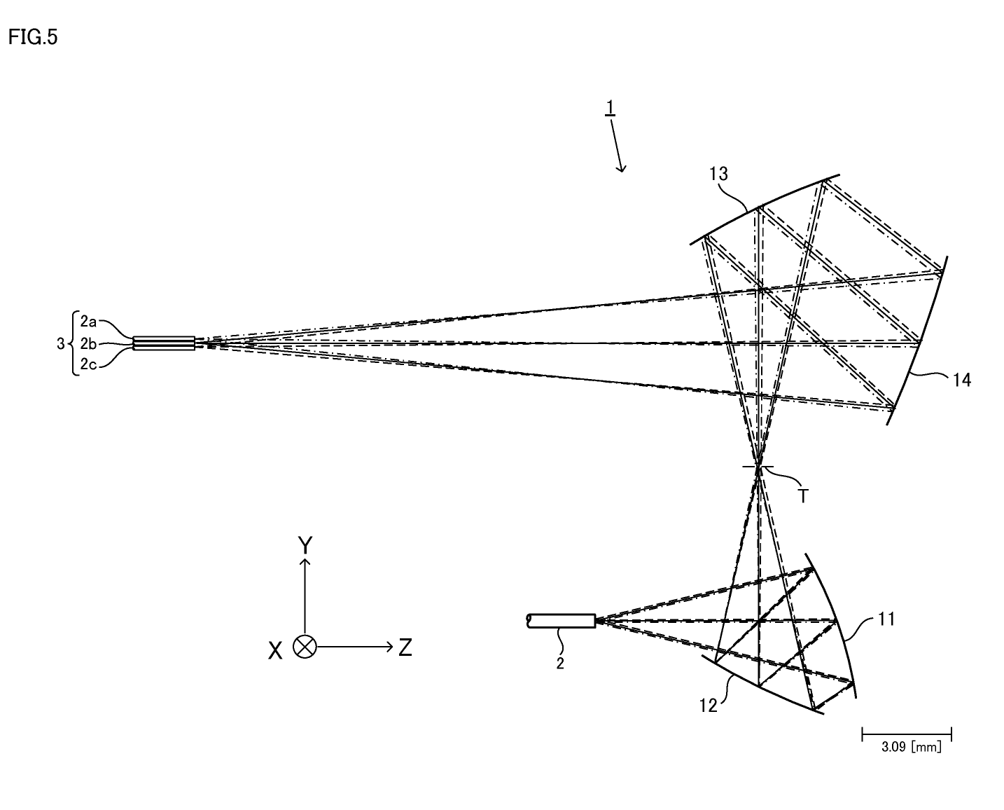

FIG. 5 is illustrative in construction of a further embodiment (Example 5) of the coupling optical system. The coupling optical system 1 of Example 5 is common to that of Example 3 or 4 in that four reflecting surfaces 11 to 14 are used; however, it is opposite to Example 4 in that a multicore fiber is used for the first optical element 2 that emits out light beams and single core fibers are used for the second optical element 3.

The coupling optical system of Example 5 comprises four reflecting surfaces 11 to 14. The respective light beams emitted out of the respective cores of the multicore fiber are reflected off the first 11, the second 12, the third 13 and the fourth reflecting surface 14 in this order for coupling at the respective core positions of the single core fibers 2a-2c (second optical element 3). Such construction of the coupling optical system 1 ensures that the respective light beams emitted out of the multicore fiber 3 are incident on the respective cores of the single core fibers 2a-2c so much so that they can be optically coupled together between the first 2 and the second optical element 3.

As is the case with Example 4, the coupling optical system is telecentric on both the first and the third reflecting surface side, with an intermediate image formed between the second 12 and the third reflecting surface 13. In turn, that intermediate image is coupled on the second optical element 3. Thus, two imaging cycles make magnification control easier. In Example 5, the distance or length from the fourth reflecting surface 14 to the second optical element 3 is long so much so that the tilt of the principal ray of an off-axis light beam incident on the second optical element 3 is kept small, leading to a more improved coupling efficiency.

The coupling optical system 1 of Example 5 is on the assumption that the numerical apertures of both the multi-core fiber forming the first optical element 2 and the single core fibers 2a-2c forming the second optical element 3 are large. For instance, this is effective for a typical case where the first optical element 2 comprises a multicore fiber having a large numerical aperture and the second optical element 3 comprises a multimode fiber.

### Example 6

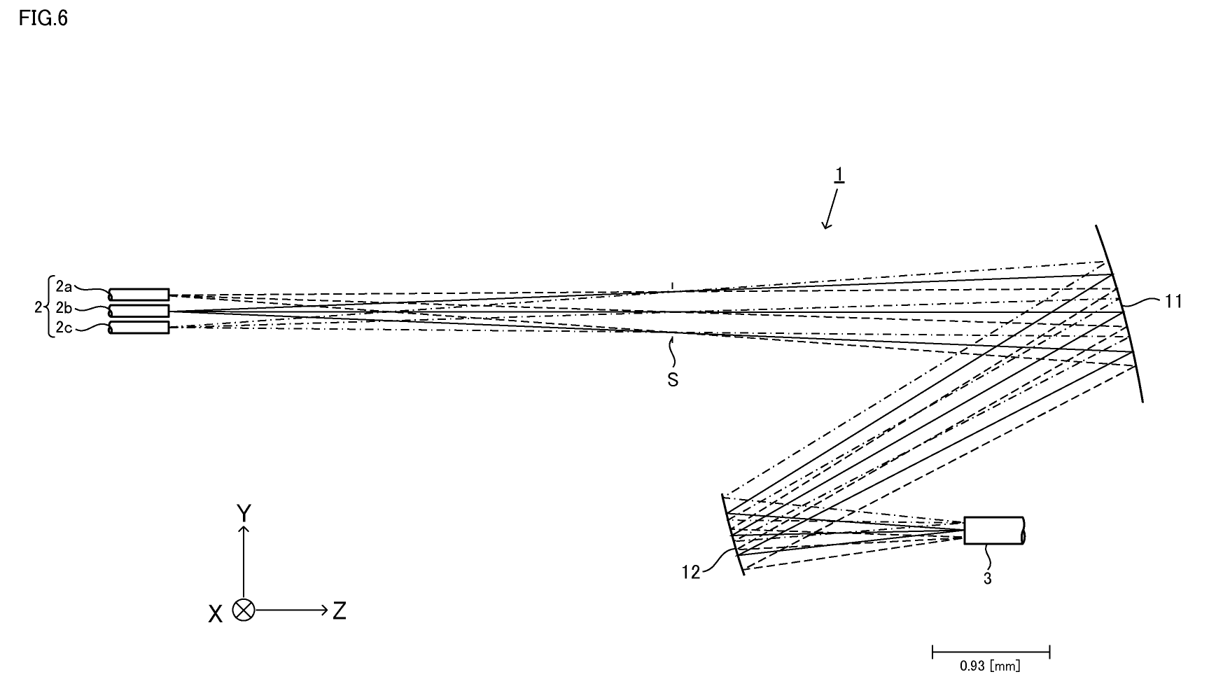

FIG. 6 is illustrative in construction of the coupling optical system (Example 6) according to a further embodiment of the invention. Example 6 is common to Examples 1 to 4 in that single core fibers 2a-2c are used for the first optical element 2 that emits out light beams and a multicore fiber 3 is used for the second optical system 3.

The coupling optical system 1 of Example 6 comprises two reflecting surfaces 11 and 12. Light beams emitted out of the cores of the respective single core fibers 2a-2c are reflected off the first reflecting surface 11 and then off the second reflecting surface 12 for coupling at the respective core positions of the multicore fiber 3 (second optical element 3). Such construction of the coupling optical system 1 ensures that the respective light beams emitted out of the single core fibers 2a-2c are incident on the respective cores of the multicore fiber 3 so much so that they are optically coupled together between the first 2 and the second optical element 3.

This coupling optical system is telecentric on the first optical element 2 side, with an aperture stop position S located near the centers of the first optical element 2 and the first reflecting surface 11, ensuring that the angles of tilt of the principal ray on both the first 2 and the second optical element 3 side have a relatively large value.

Further, Example 6 has a distinctive feature of the first 2 and the second optical element 3 being lined up almost linearly, as is the case with Example 2. Such an arrangement of Example 6 ensures that the single core fibers 2a-2c used for beam output and the multicore fiber 3 used for beam input are kept in a substantially linear relationship. On a millimeter scale, the size of the coupling optical system 1 is as extremely small as a few millimeters so much so that even when it is located between the single core fibers 2a-2c and the multicore fiber 3, it may be handled as a substantially linear fiber, resulting in facility in handling.

### Example 7

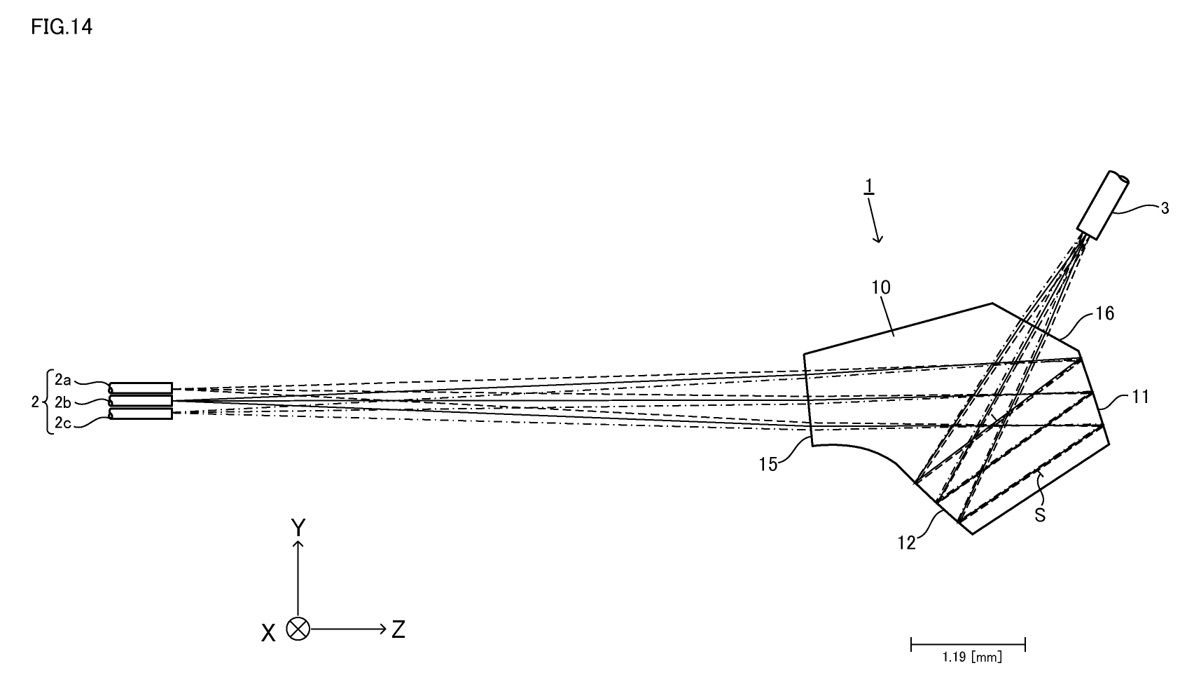

FIG. 14 is illustrative in construction of a further embodiment of the coupling optical system (Example 7). The coupling optical system 1 here comprises a decentered prism 10 filled inside with a transparent medium. Light beams emitted out of the first optical element 2 comprising a bundle of single core fibers 2a-2c with mutually parallel optical axes are incident on a multi-core fiber 3 (second optical element 3) including multiple cores. On the multicore fiber 3 side the light beams emitted out of the single fiber cores 2a-2c are incident for each core. In other words, the multiple light beams emitted out of the first optical element 2 are incident on the second optical element 3 while they are mutually separated.

The coupling optical system 1 of Example 7 comprises an entrance surface 15 (first surface), an exit surface 16 (fourth surface) and two reflecting surfaces: a first reflecting surface 11 (second surface) and a second reflecting surface 12 (third surface). In the coupling optical system 1, a space between the surfaces 11, 12, 15 and 16 is defined by the decentered prism 10 filled with a transparent medium having a reflectance of about 1.5. Light beams emitted out of the cores of the respective single core fibers 2a-2c are incident from the entrance surface 15 on the decentered prism 10, reflected off the first reflecting surface 11 (second surface 2) and then off the second reflecting surface 12 (third surface 3), exiting out of the decentered prism 10 through the exit surface 16 (fourth surface) for coupling at the second optical element 3.

Such construction of the coupling optical system 1 ensures that the respective light beams emitted out of the single core fibers 2a-2c are incident on the respective cores of the multicore fiber 3 so much so that they are optically coupled together between the first 2 and the second optical system 3.

An aperture stop position S is located between the first 11 and the second reflecting surface 12 within the decentered prism 10. Thus, although the coupling optical system here forms a non-telecentric optical arrangement on the second optical element 3 side, yet the angle of tilt of the principal ray on the second optical element 3 side can have a relatively large value, resulting in an improved coupling efficiency, because the aperture stop position S is located between the two reflecting surfaces 11 and 12 each having a positive power.

As either one of the at least two reflecting surfaces: the first 11 and the second reflecting surface 12 has a rotationally asymmetric curved surface shape, it is effective for correction of decentration aberration. This decentration aberration results from decentration of the first 11 and the second reflecting surface 12 relative to the axial principal ray.

Decentration aberration is a complicated one different from Seidel aberrations occurring in a co-axial optical system. There is much difficulty in correction of such aberration asymmetric with respect to the optical axis using a spherical surface or other surface having an axis of rotation. This is the reason why either one of the first 11 and the second reflecting surface 12 has preferably a rotational asymmetric curved surface shape for correction of aberration. In Example 7 here, there are much more improvements made in the effect on correction of decentration aberration because both the two reflecting surfaces 11 and 12 are constructed of a free-form surface that is a rotationally asymmetric surface defined by the XY polynomial.

Use of the decentered prism 10 ensures that a reflecting surface having power has internal reflection. And the power of the reflecting surface is multiplied by the reflectance of the medium with the consequence that the radius of curvature of the reflecting surface grows large (or the curvature gets small), resulting in reductions of aberrations occurring at the reflecting surface and improvements in the performance of the whole optical system. Further, with the first 11 and the second reflecting surface 12 each having a positive power, it is possible to disperse the power of the whole optical system, resulting in reductions of aberrations occurring at the respective surfaces.

When the coupling optical system 1 comprises two reflecting mirrors as in Examples 1 and 2, it is required to make precise alignment of the positions of the individual reflecting mirrors for assemblage and adjustment. The coupling optical system is constructed of one single decentered prism 10 as is the case with Example 7 here. In turn, this enables to predetermine the relative positions of the first 11 and the second reflecting surface 12, resulting in a reduction of the steps for assemblage and adjustment as well as cost reductions.

### Example 8

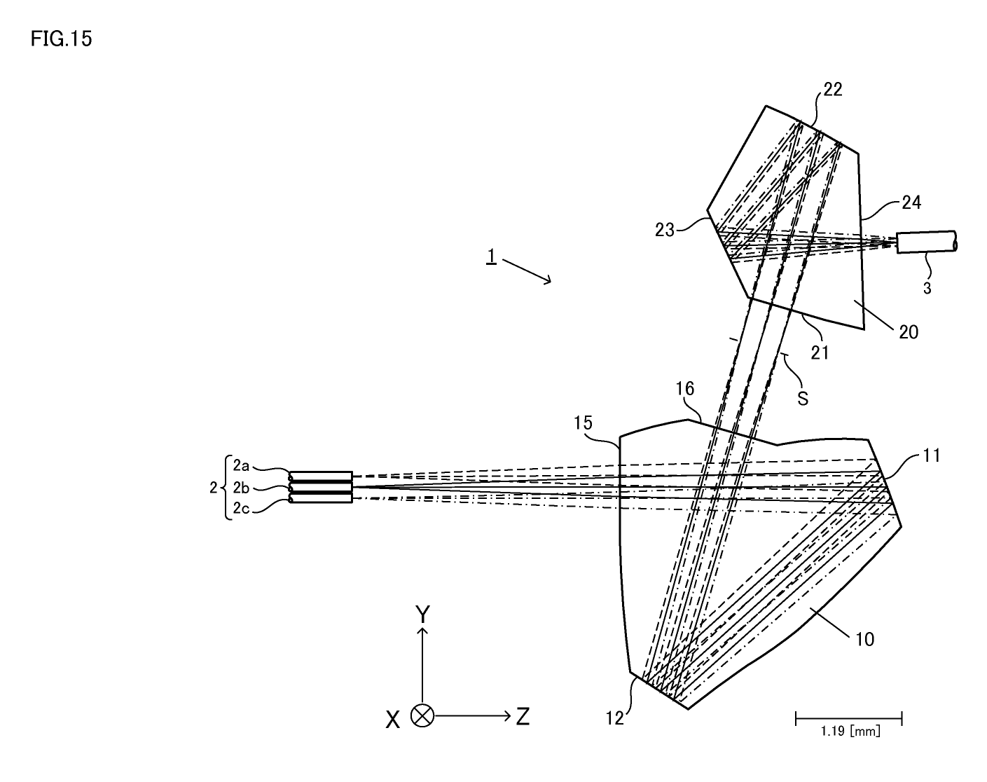

FIG. 15 is illustrative in construction of a further embodiment of the coupling optical system (Example 8). Used for the coupling optical system 1 of Example 8 are a first decentered prism 10 including two reflecting surfaces: a first reflecting surface 11 (second surface) and a second reflecting surface 12 (third surface) and a second decentered prism 20 including two reflecting surfaces: a third reflecting surface 22 (sixth surface) and a fourth reflecting surface 23 (seventh surface). Single core fibers 2a-2c are used for the first optical element 2 that emits out light beams and a multicore fiber 3 is used for the second optical element 3 as in the aforesaid examples.

The coupling optical system 1 of Example 8 includes, and is constructed of, two prisms: a first decentered prism 10 and a second decentered prism 20. The respective light beams emitted out of the cores of the respective single core fibers 2a-2c are incident from an entrance surface 15 (first surface) on the first decentered prism 10. Then, they are reflected off the first reflecting surface 11 (second surface) and the second reflecting surface 12 (third surface), respectively, going out of an exit surface 16 (fourth surface) and entering the decentered prism 20. Then, they are incident from an entrance surface 21 (fifth surface) on the second decentered prism 20, and reflected off the third reflecting surface 22 (sixth surface) and the fourth reflecting surface 23 (seventh surface) in this order, exiting out of an exit surface 24 (eighth surface) for coupling at the respective core positions of the multicore fiber 3 (second optical element 3). Such construction of the coupling optical system 1 ensures that the respective light beams emitted out of the single core fibers 2a-2c are incident on the respective cores of the multicore fiber 3 so much so that they can be optically coupled together between the first 2 and the second optical element 3.

Example 8 is characterized in that there is a pupil formed between the first 10 and the second decentered prism 20. A front group of the coupling optical system 1 is defined by the first decentered prism 1, and the pupil is formed near the back focal position of the front group and in alignment with the front focal position of a rear group defined by the second decentered prism 20. Such coupling optical system 1 is telecentric on both the first 12 and the second optical element 3.

When multiple light beams are put in, or put out of, the second optical element 3, for instance in the case of a multicore fiber including multiple cores such as the one used in the examples herein or a bundle of multiple single core fibers, they are preferably placed in a parallel state because of facility in handling. The respective cores of an ordinary multicore fiber remain placed in parallel, so are the optical axes (principal rays) emitted out of them. To simultaneously and efficiently take the multiple light beams emitted out of the first optical element 2 in the coupling optical system 1 or to improve coupling efficiency, therefore, it is desired that the coupling optical system be telecentric on the second optical element 3 side.

In a mode or the like of bidirectional communications between the first 2 and the second optical element 3, the second optical element 3 is positioned on the output side and the first optical element 2 is positioned on the input side. It is then preferable that the coupling optical system be telecentric on the first optical element 2 side, too, for the same reason as described above.

When reflecting mirrors are used as the reflecting surfaces in Example 3, it is required to make precise alignment and adjustment of the positions of four reflecting mirrors. In Example 8 where the coupling optical system 1 is constructed of two decentered prisms 10 and 20, there is only the need of adjusting the positions of the two decentered prisms 10 and 20, which is facile in assemblage and adjustment and renders cost reductions possible because of less steps involved.

### Example 9

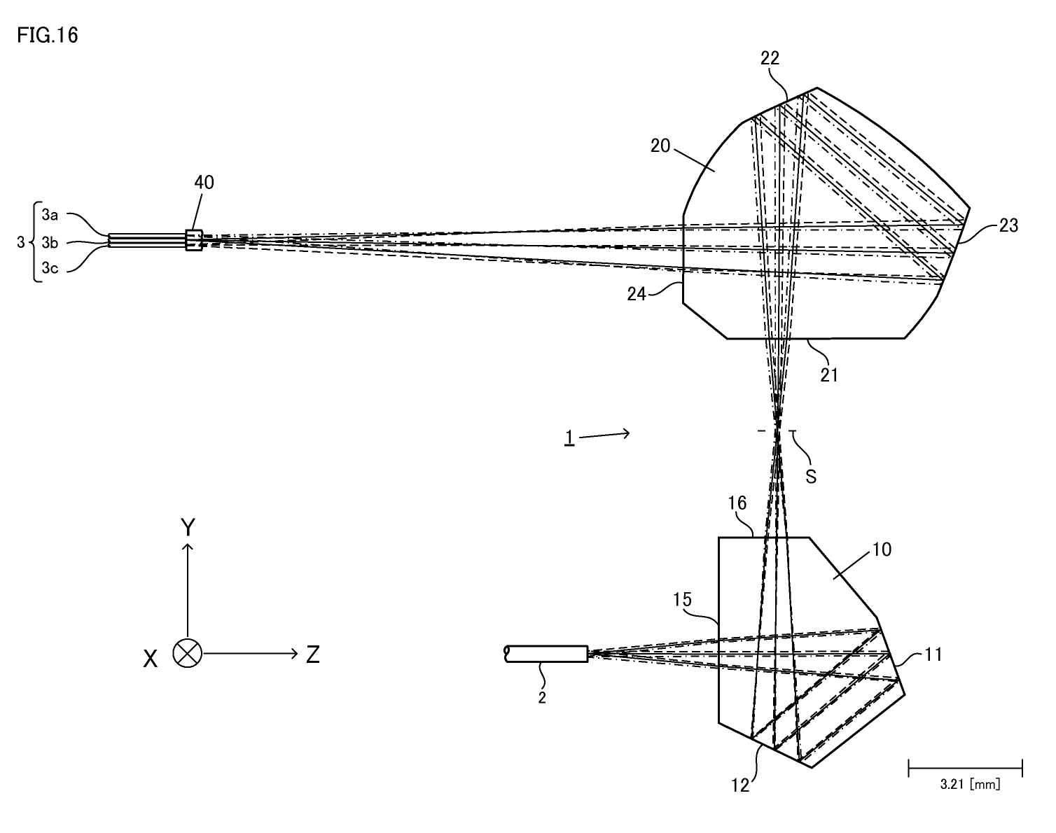

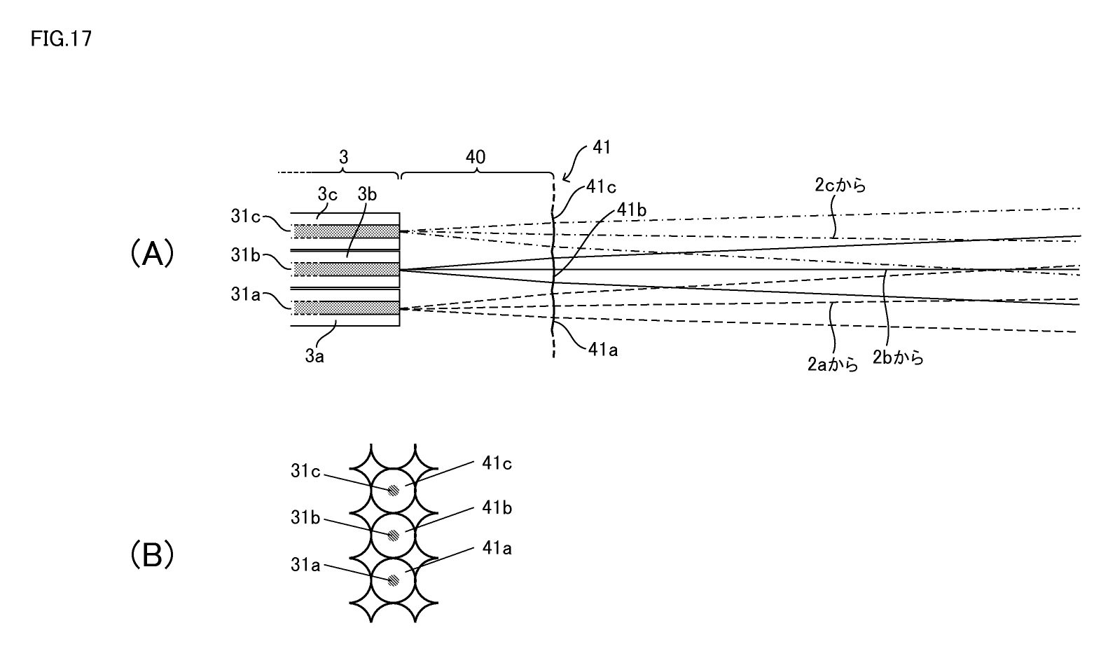

FIG. 16 is illustrative in construction of a further embodiment of the coupling optical system (Example 9). The coupling optical system 1 of Example 9 is common to that of Example 8 in that there are two decentered prisms 10 and 20 used, but Example 9 is opposite to Example 8 in that a multicore fiber is used for the first optical element 2 that emits out light beams and single core fibers are used for the second optical element 3. Further in this embodiment, a microlens array 20 (called herein the “adjustment optical element”) is located on the respective coupling points on the entrance surface of the second optical element 3. This microlens array 20 is a two-dimensional array of lenses having positive power. The microlens array is preferably located on the single core fibers side having a long core separation as in Example 9, because it has a favorable effect on the physical array (unit surfaces of FIG. 17) of micro-lenses (by which any interference between adjoining lenses can be overcome) and on microlens processing as well.

The coupling optical system 1 of Example 9 comprises two decentered prisms 10 and 20. The respective light beams emitted out of the respective cores of the multicore fiber are incident from an entrance surface 15 (first surface) on the first decentered prism 10, and then reflected off the first reflecting surface 11 (second surface) and the second reflecting surface 12 (third surface), respectively, exiting out of an exit surface 16 (fourth surface) and entering the second decentered prism 20. To be specific, they are incident from an entrance surface 21 (fifth surface) on the second decentered prism 20, and reflected off the third reflecting surface 22 (sixth surface) and the fourth reflecting surface 23 (seventh surface) in this order, exiting out of an exit surface 24 (eighth surface).

FIG. 17 is illustrative of the vicinity of a multi-lens array 40 working as the adjustment optical element in Example 9. FIG. 17(A) is a sectional view of the micro-lens array 40 as viewed from the same direction as in FIG. 16, and FIG. 17(B) is a front view of the microlens array 40 as viewed from the Z-axis positive direction in FIG. 16. In Example 9, the microlens array 40 is used as the adjustment optical element for adjusting a numerical aperture (NA) and holding back light losses upon incidence. In Example 9, the microlens array 40 is positioned in contact with the second optical element 3; however, it may be positioned near the second optical element 3. The entrance surface 41 of the microlens array 40 is provided with convex unit surfaces 41a-41c to form a lens having positive power. The microlens array 40 is located such that the respective unit surfaces 41a-41c are in alignment with the cores 31a-31c of the respective single core fibers 3a-3c. Such location of the microlens 40 ensures that the light beams emitted out of the multicore fiber 2 operating as the second optical element 2 are incident on the respective unit surfaces 41a-41c and then on the cores 31a-31c of the respective single cores 3a-3c so much so that they can be optically coupled together between the first 2 and the second optical element 3.

In Example 9 here, the coupling optical system is telecentric on the first optical element 2 side, with an intermediate image formed between the first 10 and the second decentered prism 20. In turn, that intermediate image is coupled on the second optical element 3. Thus, two imaging cycles make magnification control easier without giving rise to any malfunction.

For example, a multicore fiber separation is 50 μm and the cladding diameter of single core fibers is 125 μm. For this reason, a magnification m of at least 1 is needed so as to achieve optical coupling of the multicore fiber first optical element 2 to the second optical element 3 comprising multiple single core fibers, as can be seen from Example 9 of FIG. 16. Preferably, this magnification m should be set as a ratio between a numerical aperture NA on the first optical element 2 side and a numerical aperture NA′ on the second optical element 3 side (NA/NA′) for the purpose of reducing optical losses. In Example 9, there is one-way incidence of light beams from the first 2 to the second optical element 3, but setting the numerical apertures NA and NA′ at proper values is particularly effective for a case where light beams are put in and out in two-way directions.

Through proper adjustment of the numerical aperture NA′ on the second optical element 3 side, the microlens array 40 of Example 9 functions well as the adjustment optical element for holding back optical losses. In Example 9 here, the adjustment optical element used has a positive power because the magnification m is greater than 1. When the magnification m is less than 1 or the adjustment optical element is located on the first optical element 2 side, however, it is possible to give a proper negative power to the adjustment optical element thereby determining proper numerical apertures NA and NA′ for the magnification m.

In the absence of the microlens array 20 in Example 9 here, the numerical aperture (NA′) of the coupling optical system on the second optical element 2 side was 0.04; however, the numerical aperture (NA′) on the second optical element 3 side increased up to 0.18 by use of the microlens array 20.

Following the explanation of the constructions of Examples 1 to 9, the telecentric states of the respective coupling optical systems on the first and the second optical element side are tabulated in Table 1.

TABLE 1

| | 1^{st} Optical | 2^{nd} Optical |
|---|---|---|
| | Element Side | Element Side |
| Ex. 1 | Telecentric | Non- |
| | | Telecentric |
| Ex. 2 | Non- | Telecentric |
| | Telecentrica | |
| Ex. 3 | Telecentric | Telecentric |
| Ex. 4 | Telecentric | Non- |
| | | Telecentric |
| Ex. 5 | Telecentric | Non- |
| | | Telecentric |
| Ex. 6 | Non- | Non- |
| | Telecentrica | Telecentric |
| Ex. 7 | Telecentric | Non- |
| | | Telecentric |
| Ex. 8 | Telecentric | Telecentric |
| Ex. 8 | Telecentric | Non- |
| | | Telecentric |

The present invention has been explained with reference to Examples 1 to 9. It is here to be noted that if the respective examples are modified or otherwise altered, it is then possible to obtain such advantages as described below.

For such coupling optical system 1, it is preferable that the medium of either one of the reflecting surface or the decentered prism is plastic.

As the reflecting surface or the decentered prism is formed of a plastic material, it may be manufactured by injection molding by a mold thereby cutting back manufacturing cost.

For such coupling optical system 1, it is preferable that the medium of either one of the reflecting surface or the decentered prism is glass.

As the reflecting surface or the decentered prism is formed of a glass material, it may be manufactured by an abrasion that is a conventional optical elements manufacturing process thereby getting high precision. In addition, the glass may add satisfactory resistance to temperature, etc. to it.

For such coupling optical system 1, it is preferable that any one of the reflecting surfaces is metal coated.

Metals, because of having high reflectance over a wide range of wavelengths, are effective for a wide band of light and electromagnetic waves. Gold is particularly effective because of having a high reflectance for visible light having a wavelength of 400 nm or longer, long wavelength light like infrared light, and electromagnetic waves.

For such coupling optical system 1, it is preferable that any one of the reflecting surfaces is coated with a dielectric multilayer film.

Comprising a laminate of dielectric thin films, the dielectric multilayer film has a high reflectance in any wavelength band; so it is effective for coupling in a desired band. In particular, that film is effective for use in narrow bands.

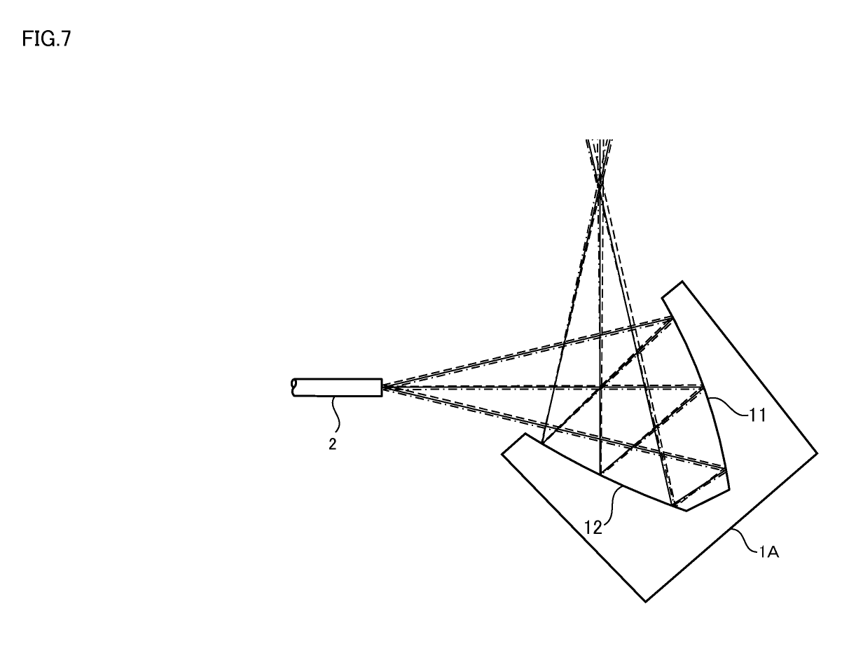

For such coupling optical system 1, it is preferable that at least two reflecting surfaces are integrated together at their back sides. FIG. 7 is illustrative in construction of Example 5 explained with reference to FIG. 5, wherein the first 11 and the second reflecting surface 12 are integrated together at their back sides to provide a form of optical unit 1A.

Thus, in an arrangement comprising multiple reflecting surfaces adjacent to one another at a certain angle, they may be integrated together at their back sides. That is, turning multiple such reflecting surfaces into one optical element brings about some merits. First, the incorporation of multiple reflecting surfaces in one element allows for predetermination of their relative positions. There is thus no need for assemblage and adjustment taking the relative positions of the reflecting surfaces into account. This in turn results in elimination of any excess step so much so that step counts reductions and cost curtailments are achievable. Second, one optical element may be manufactured by a molding process using a mold. It is thus possible to accommodate mass manufacturing with stabilized quality.

While FIG. 7 shows one form of the first 11 and the second reflecting surface 12 integrated together on their back sides, it is to be understood that if other surfaces (third 13, fourth reflecting surface 14 or the like) are integrated together, the aforesaid advantages get more noticeable.

In what follows, Examples 1 to 9 of the coupling optical system of the invention is now paraphrased with reference to numerical examples. Note here that the constituting parameters of the respective examples will be given later.

First of all, the coordinate system, decentered surface and free-form surface used in Examples 1 to 6 are explained. As shown in FIG. 1, an axial principal ray in each example is defined by a ray coming out of the center of a single core fiber 2b working as a unit optical element in a first optical element 2 and then reflected off each reflecting surface, eventually arriving at the center of a second optical element 3 (multicore fiber), and the origin of the coordinate system is defined by the center of the single core fiber 2a positioned at the center within the first optical element 2. The Z-axis positive direction is defined by a direction propagating along that axial principal ray, the Y-Z plane is defined by a plane including the Z-axis and the center of the image plane, the X-axis positive direction is defined by a direction orthogonal to the Y-Z plane through the origin and going from the front surface of the sheet down to the back surface, and the Y-axis is defined by an axis that forms with the X- and Z-axes a right-handed orthogonal coordinate system.

It is here to be understood that it is in Examples 1-4 and Examples 6-8 that the first optical element is a single core fiber while the second optical element is a multicore fiber, and it is in Examples 5 and 9 that the first optical element is a multicore fiber while the second optical element is a single core fiber.

Given to each decentered surface are the amount of decentration of the coordinate system—on which that surface is defined—from the center of the origin of the optical system (X, Y and Z in the X-, Y- and Z-axis directions) and the angles (α, β, γ(°)) of tilt of the center axis of that surface (the Z-axis of the aforesaid (a) formula in the case of the free-form surface) about the X-, Y- and Z-axes of the coordinate system defined on the origin of the optical system. Then, the positive α and β mean counterclockwise rotation with respect to the positive directions of the respective axes, and the positive γ means clockwise rotation with respect to the positive direction of the Z-axis.

Referring here to the α, β, γ rotation of the center axis of a certain surface, the center axis of the surface and its XYZ orthogonal coordinate system are first α rotated counterclockwise about the X-axis. Then, the center axis of the rotated surface is β rotated counterclockwise about the Y-axis of a new coordinate system, and the once rotation coordinate system, too, is β rotated counterclockwise about the Y-axis. Finally, the center axis of the twice rotated surface is γ rotated clockwise about the Z-axis of a new coordinate system.

When a specific surface of the optical function surfaces forming the coupling optical system of each example and the subsequent surface form together a coaxial optical system, there is a surface separation given. In addition, there are d-line (587.6 nm) refractive index and d-line Abbe constant of a medium, etc.

The surface shape of the free-form surface used in the invention is defined by the following formula (a). Note here that the Z-axis of that defining formula is the axis of the free-form surface.

$$Z = ( {r}^{2} / R ) / [ 1 + \sqrt{ } \{ 1 - ( 1 + k ) {( r / R )}^{2} \} ] + {\sum }_{j = 1}^{∞} {C}_{j} {X}^{m} {Y}^{n} \qquad ( a )$$

Here the first terms of Formula (a) is the spherical term, and the second term is the free-form surface term.

In the spherical term,

R is the radius of curvature of the apex,

k is the conic constant, and

r is √ (X²+Y²).

The free-form surface term is:

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} \qquad ( b )$$

where Cⱼ (j is an integer of 1 or greater) is a coefficient. Note here that the symbol “e” indicates that the subsequent numerical value is a power exponent having 10 as a base. For instance, “1.0E-005” means “1.0×10⁻⁵”.

The aforesaid defining formula (a) is given for the sake of illustration alone as mentioned above: the feature of the invention is that by use of the rotationally asymmetric surface having no plane of symmetry, it is possible to correct rotationally asymmetric aberrations occurring from decentration in the X-Z plane as well as in the Y-Z plane. It goes without saying that the same advantages are achievable even with any other defining formulae.

It is here to be understood that the term regarding the free-form surface with no data given to it is zero. Length is given in mm. In what follows, numerical examples for Examples 1 to 9 are tabulated below. In these tables “FFS” stands for a free-form surface.

In Examples 1-4 and Examples 6-8, the light beam position on the first optical element side and what corresponds to an object height referred usually to in the optical system art are defined as set out in the following Table 2, with F1 (Field 1) as center and F2-F6 as off-axis.

TABLE 2

| | X [mm] | Y [mm] |
|---|---|---|
| F1 | 0 | 0 |
| F2 | 0 | −0.125 |
| F3 | 0.125 | −0.125 |
| F4 | 0.125 | 0 |
| F5 | 0.125 | 0.125 |
| F6 | 0 | 0.125 |

In Examples 1-4 and Examples 6-8, the off-axis image height (core position) of the second optical element is about 50 μm in both X and Y.

In Examples 5 and 9, the light beam position on the first optical element side and what corresponds to an object height referred usually to in the optical system art are defined as set out in the following Table 3, with F1 (Field 1) as center and F2-F6 as off-axis.

TABLE 3

| | X [mm] | Y [mm] |
|---|---|---|
| F1 | 0 | 0 |
| F2 | 0 | −0.05 |
| F3 | 0.05 | −0.05 |
| F4 | 0.05 | 0 |
| F5 | 0.05 | 0.05 |
| F6 | 0 | 0.05 |

In Examples 5 and 9, the off-axis image height (core position) of the second optical element is about 125 μm in both X and Y.

### Example 1

| | Radius of | Surface | |
|---|---|---|---|
| Surface No. | Curvature | Separation | Decentration |
| Object Plane | ∞ | 7.00 | |
| 1 | FFS[1] | −2.22 | Decentration [1] |
| 2 | FFS[2] | 2.31 | Decentration [2] |
| Image Plane | ∞ | | Decentration [3] |

FFS[1]

| | | | | | |
|---|---|---|---|---|---|
| C4 | −5.5127e−002 | C6 | −5.3904e−002 | C8 | 6.6771e−003 |
| C10 | 2.4128e−003 | C11 | −3.5272e−003 | C13 | −6.4953e−003 |
| C15 | 7.8851e−003 | C17 | −1.4933e−002 | C19 | −2.0163e−002 |
| C21 | 1.1484e−002 | C22 | 6.1004e−003 | C24 | 5.4975e−003 |
| C26 | −1.0021e−002 | C28 | 6.5009e−003 | | |

FFS[2]

| | | | | | |
|---|---|---|---|---|---|
| C4 | 8.6001e−002 | C6 | 8.0515e−002 | C8 | 1.3885e−002 |
| C10 | 5.6544e−003 | C11 | 2.7342e−003 | C13 | 1.6493e−002 |
| C15 | −2.1588e−003 | C17 | −4.7993e−002 | C19 | −2.3777e−003 |
| C21 | −1.2903e−002 | C22 | 5.9853e−002 | C24 | 1.3277e−002 |
| C26 | −5.0546e−002 | C28 | 3.6654e−002 | | |

Decentration [1]

| | | | | | |
|---|---|---|---|---|---|
| X | 0.00 | Y | 0.21 | Z | 0.00 |
| α | 16.81 | β | 0.00 | γ | 0.00 |

Decentration [2]

| | | | | | |
|---|---|---|---|---|---|
| X | 0.00 | Y | −0.25 | Z | 0.00 |
| α | 10.15 | β | 0.00 | γ | 0.00 |

Decentration [3]

| | | | | | |
|---|---|---|---|---|---|
| X | 0.00 | Y | 0.14 | Z | 0.00 |
| α | 0.00 | β | 0.00 | γ | 0.00 |

### Example 2

| | Radius of | Surface | |
|---|---|---|---|
| Surface No. | Curvature | Separation | Decentration |
| Object Plane | ∞ | 7.00 | |
| 1 | FFS[1] | −2.25 | Decentration [1] |
| 2 | (Stop Surface) | −2.25 | |
| 3 | FFS[2] | 0.93 | Decentration [2] |
| Image Plane | ∞ | | Decentration [3] |

FFS[1]

| | | | | | |
|---|---|---|---|---|---|
| C4 | −7.7845e−002 | C6 | −7.4228e−002 | C8 | 9.6832e−004 |
| C10 | 6.3398e−004 | C11 | −7.8254e−004 | C13 | −2.3226e−003 |
| C15 | 1.5682e−003 | C17 | −3.1223e−004 | C19 | −3.4569e−003 |
| C21 | 5.7663e−003 | C22 | 8.2889e−003 | C24 | −1.8483e−003 |
| C26 | 4.7687e−003 | C28 | 6.3965e−003 | | |

FFS[2]

| | | | | | |
|---|---|---|---|---|---|
| C4 | 1.2932e−001 | C6 | 1.0344e−001 | C8 | 3.5182e−002 |
| C10 | 9.9069e−003 | C11 | −4.5661e−001 | C13 | −1.4546e+000 |
| C15 | 7.8676e−002 | C17 | 3.7283e+000 | C19 | 4.1815e+000 |
| C21 | −2.6033e−001 | | | | |

Decentration [1]

| | | | | | |
|---|---|---|---|---|---|
| X | 0.00 | Y | 0.23 | Z | 0.00 |
| α | 15.00 | β | 0.00 | γ | 0.00 |

Decentration [2]

| | | | | | |
|---|---|---|---|---|---|
| X | 0.00 | Y | −0.00 | Z | 0.00 |
| α | −15.00 | β | 0.00 | γ | 0.00 |

Decentration [3]

| | | | | | |
|---|---|---|---|---|---|
| X | 0.00 | Y | 0.12 | Z | 0.00 |
| α | 0.00 | β | 0.00 | γ | 0.00 |

### Example 3

| | Radius of | Surface | |
|---|---|---|---|
| Surface No. | Curvature | Separation | Decentration |
| Object Plane | ∞ | 6.98 | |
| 1 | FFS[1] | −3.44 | Decentration [1] |
| 2 | FFS[2] | 4.58 | Decentration [2] |
| 3 | (Stop Surface) | 2.01 | |
| 4 | FFS[3] | −1.79 | Decentration [3] |
| 5 | FFS[4] | 2.05 | Decentration [4] |
| Image Plane | ∞ | | Decentration [5] |

FFS[1]

| | | | | | |
|---|---|---|---|---|---|
| C4 | −1.9104e−002 | C6 | −5.3305e−002 | C8 | 1.6298e−003 |
| C10 | 1.2011e−003 | C11 | −9.4356e−003 | C13 | −1.5133e−003 |
| C15 | −7.4674e−003 | C17 | −3.6057e−003 | C19 | 2.9045e−003 |
| C21 | 6.7383e−003 | C22 | 2.2605e−002 | C24 | −1.8528e−003 |
| C26 | 3.7759e−003 | C28 | 9.5199e−002 | | |

FFS[2]

| | | | | | |
|---|---|---|---|---|---|
| C4 | 3.4076e−002 | C6 | −2.4023e−002 | C8 | 3.0931e−003 |
| C10 | 8.0351e−003 | C11 | −7.4114e−003 | C13 | −3.7755e−003 |
| C15 | −2.2197e−002 | C17 | −2.1559e−003 | C19 | 4.6989e−003 |
| C21 | 9.6791e−003 | C22 | 1.1872e−002 | C24 | −2.0821e−003 |
| C26 | 3.7956e−003 | C28 | 4.2807e−001 | | |

FFS[3]

| | | | | | |
|---|---|---|---|---|---|
| C4 | −6.7091e−002 | C6 | −1.0008e−001 | C7 | −7.8788e−006 |
| C9 | 3.1025e−005 | C11 | −2.4738e−002 | C13 | 5.5802e−004 |
| C15 | 7.5657e−003 | C17 | −4.7242e−003 | C19 | 4.1969e−003 |
| C21 | −4.0770e−004 | C22 | 2.6547e−001 | C24 | −3.9739e−003 |
| C26 | −3.1784e−005 | C28 | −6.0903e−002 | | |

FFS[4]

| | | | | | |
|---|---|---|---|---|---|
| C4 | 9.2903e−002 | C6 | 3.8360e−002 | C8 | −6.6881e−003 |
| C10 | −9.7244e−003 | C11 | −2.3133e−002 | C13 | −2.0554e−002 |
| C15 | 1.9512e−002 | C17 | −1.5766e−002 | C19 | 5.3190e−002 |
| C21 | −1.4653e−002 | C22 | 3.7863e−001 | C24 | −4.8945e−003 |
| C26 | −3.4467e−002 | C28 | 9.7846e−004 | | |

Decentration [1]

| | | | | | |
|---|---|---|---|---|---|
| X | 0.00 | Y | 0.02 | Z | 0.00 |
| α | 20.82 | β | 0.00 | γ | 0.00 |

Decentration [2]

| | | | | | |
|---|---|---|---|---|---|
| X | 0.00 | Y | 0.00 | Z | 0.00 |
| α | 13.45 | β | 0.00 | γ | 0.00 |

Decentration [3]

| | | | | | |
|---|---|---|---|---|---|
| X | 0.00 | Y | −0.00 | Z | 0.00 |
| α | −18.13 | β | 0.00 | γ | 0.00 |

Decentration [4]

| | | | | | |
|---|---|---|---|---|---|
| X | 0.00 | Y | −0.25 | Z | 0.00 |
| α | −22.20 | β | 0.00 | γ | 0.00 |

Decentration [5]

| | | | | | |
|---|---|---|---|---|---|
| X | 0.00 | Y | 0.20 | Z | 0.00 |
| α | −1.40 | β | 0.00 | γ | 0.00 |

### Example 4

| | Radius of | Surface | |
|---|---|---|---|
| Surface No. | Curvature | Separation | Decentration |
| Object Plane | ∞ | 23.37 | |
| 1 | FFS [1] | −15.00 | Decentration [1] |
| 2 | FFS [2] | 10.61 | Decentration [2] |
| 3 | (Intermediate Image) | 7.47 | |
| 4 | FFS [3] | −6.00 | Decentration [3] |
| 5 | FFS [4] | 8.01 | Decentration [4] |
| Image Plane | ∞ | | Decentration [5] |

FFS [1]

| | | | | | |
|---|---|---|---|---|---|
| C4 | −1.2497e−002 | C6 | −1.0928e−002 | C8 | 1.1679e−004 |
| C10 | −2.1559e−004 | C11 | 2.8041e−005 | C13 | 4.9629e−005 |
| C15 | −4.5566e−007 | C17 | −2.0432e−006 | C19 | −4.4983e−006 |
| C21 | 1.0706e−007 | C22 | −3.4704e−006 | C24 | −1.6027e−007 |
| C26 | −1.7393e−006 | C28 | 9.4325e−007 | | |

FFS [2]

| | | | | | |
|---|---|---|---|---|---|
| C4 | 2.4960e−002 | C6 | 2.0998e−002 | C8 | 4.3377e−004 |
| C10 | 5.0720e−005 | C11 | 3.9062e−005 | C13 | −4.2278e−006 |
| C15 | 3.9838e−006 | C17 | 7.9259e−007 | C19 | −2.6788e−006 |
| C21 | −1.0534e−006 | C22 | −1.0110e−005 | C24 | 5.5863e−007 |
| C26 | −1.5815e−006 | C28 | 6.5141e−007 | | |

FFS [3]

| | | | | | |
|---|---|---|---|---|---|
| C4 | −2.4855e−002 | C6 | −2.0946e−002 | C8 | −1.2607e−003 |
| C10 | −2.2763e−003 | C11 | 5.5710e−005 | C13 | 5.2795e−004 |
| C15 | 2.6014e−004 | C17 | −1.0835e−005 | C19 | −7.7926e−005 |
| C21 | −2.9762e−005 | C22 | 5.6114e−005 | C24 | 1.5449e−005 |
| C26 | 2.5288e−005 | C28 | −4.1348e−007 | | |

FFS [4]

| | | | | | |
|---|---|---|---|---|---|
| C4 | 4.1698e−002 | C6 | 3.6946e−002 | C8 | −2.8327e−005 |
| C10 | −6.4870e−004 | C11 | 7.8453e−005 | C13 | 3.6890e−004 |
| C15 | 8.7348e−005 | C17 | 6.3856e−006 | C19 | 6.9074e−006 |
| C21 | −1.5042e−005 | C22 | 1.7442e−005 | C24 | 2.2602e−006 |
| C26 | 8.4645e−006 | C28 | 4.9824e−007 | | |

Decentration [1]

| | | | | | |
|---|---|---|---|---|---|
| X | 0.00 | Y | 0.00 | Z | 0.00 |
| α | 22.21 | β | 0.00 | γ | 0.00 |

Decentration [2]

| | | | | | |
|---|---|---|---|---|---|
| X | 0.00 | Y | 0.00 | Z | 0.00 |
| α | 24.10 | β | 0.00 | γ | 0.00 |

Decentration [3]

| | | | | | |
|---|---|---|---|---|---|
| X | 0.00 | Y | 0.00 | Z | 0.00 |
| α | 22.65 | β | 0.00 | γ | 0.00 |

Decentration [4]

| | | | | | |
|---|---|---|---|---|---|
| X | 0.00 | Y | −0.02 | Z | 0.00 |
| α | 19.05 | β | 0.00 | γ | 0.00 |

Decentration [5]

| | | | | | |
|---|---|---|---|---|---|
| X | 0.00 | Y | −0.01 | Z | 0.00 |
| α | −0.20 | β | 0.00 | γ | 0.00 |

### Example 5

| | Radius of | Surface | |
|---|---|---|---|
| Surface No. | Curvature | Separation | Decentration |
| Object Plane | ∞ | 8.33 | |
| 1 | FFS [1] | −3.50 | Decentration [1] |
| 2 | FFS [2] | 7.51 | Decentration [2] |
| 3 | (Intermediate Image) | 8.87 | |
| 4 | FFS [3] | −7.24 | Decentration [3] |
| 5 | FFS [4] | 25.00 | Decentration [4] |
| Image Plane | ∞ | | |

FFS [1]

| | | | | | |
|---|---|---|---|---|---|
| C4 | −4.1420e−002 | C6 | −3.6927e−002 | C8 | −1.3769e−003 |
| C10 | −2.0498e−004 | C11 | −5.1136e−005 | C13 | −1.5100e−004 |
| C15 | −1.3584e−004 | C17 | −4.3828e−006 | C19 | −5.6718e−006 |
| C21 | 1.6392e−005 | C22 | −8.2070e−007 | C24 | −1.2453e−006 |
| C26 | −4.3402e−007 | C28 | −2.1866e−006 | | |

FFS [2]

| | | | | | |
|---|---|---|---|---|---|
| C4 | 2.5625e−002 | C6 | 2.1156e−002 | C8 | 4.3239e−004 |
| C10 | 1.0932e−003 | C11 | −6.3275e−005 | C13 | −2.2617e−004 |
| C15 | −1.6653e−004 | C17 | −5.0774e−006 | C19 | −2.7538e−005 |
| C21 | 1.4328e−005 | | | | |

FFS [3]

| | | | | | |
|---|---|---|---|---|---|
| C4 | −2.5267e−002 | C6 | −2.1341e−002 | C8 | −3.5638e−004 |
| C10 | −5.4353e−004 | C11 | −1.8881e−005 | C13 | 5.4274e−005 |
| C15 | 2.2742e−005 | C17 | 1.3798e−006 | C19 | −5.4585e−007 |
| C21 | −2.4738e−007 | C67 | 2.0000e+001 | | |

FFS [4]

| | | | | | |
|---|---|---|---|---|---|
| C4 | 1.5456e−002 | C6 | 1.2865e−002 | C8 | 5.6809e−004 |
| C10 | 1.2696e−005 | C11 | −1.1743e−005 | C13 | 8.9931e−005 |
| C15 | 3.4653e−005 | | | | |

Decentration [1]

| | | | | | |
|---|---|---|---|---|---|
| X | 0.00 | Y | 0.00 | Z | 0.00 |
| α | 20.00 | β | 0.00 | γ | 0.00 |

Decentration [2]

| | | | | | |
|---|---|---|---|---|---|
| X | 0.00 | Y | 0.00 | Z | 0.00 |
| α | 25.00 | β | 0.00 | γ | 0.00 |

Decentration [3]

| | | | | | |
|---|---|---|---|---|---|
| X | 0.00 | Y | 0.00 | Z | 0.00 |
| α | 25.00 | β | 0.00 | γ | 0.00 |

Decentration [4]

| | | | | | |
|---|---|---|---|---|---|
| X | 0.00 | Y | 0.00 | Z | 0.00 |
| α | 20.00 | β | 0.00 | γ | 0.00 |

### Example 6

| | Radius of | Surface | |
|---|---|---|---|
| Surface No. | Curvature | Separation | Decentration |
| Object Plane | ∞ | 4.00 | |
| 1 | (Stop Surface) | 3.57 | |
| 2 | FFS [1] | −3.57 | Decentration [1] |
| 3 | FFS [2] | 1.86 | Decentration [2] |
| Image Plane | ∞ | | Decentration [3] |

FFS [1]

| | | | | | |
|---|---|---|---|---|---|
| C4 | −6.5378e−002 | C6 | −6.2497e−002 | C8 | 5.0760e−003 |
| C10 | 1.3543e−003 | C11 | −2.9326e−003 | C13 | 3.3323e−004 |
| C15 | −2.2918e−005 | C17 | −1.7928e−002 | C19 | −6.9060e−003 |
| C21 | 4.9163e−004 | C22 | 2.5692e−002 | C24 | −1.9344e−002 |
| C26 | 1.0149e−002 | C28 | 3.7377e−004 | | |

FFS [2]

| | | | | | |
|---|---|---|---|---|---|
| C4 | 8.4002e−002 | C6 | 7.3804e−002 | C8 | 2.1710e−002 |
| C10 | 8.1022e−004 | C11 | −1.6393e−002 | C13 | −3.1311e−003 |
| C15 | 2.3812e−003 | C17 | −5.0951e−001 | C19 | −1.4155e−001 |
| C21 | 1.2692e−002 | | | | |

Decentration [1]

| | | | | | |
|---|---|---|---|---|---|
| X | 0.00 | Y | 0.04 | Z | 0.00 |
| α | 15.00 | β | 0.00 | γ | 0.00 |

Decentration [2]

| | | | | | |
|---|---|---|---|---|---|
| X | 0.00 | Y | 0.04 | Z | 0.00 |
| α | −15.00 | β | 0.00 | γ | 0.00 |

Decentration [3]

| | | | | | |
|---|---|---|---|---|---|
| X | 0.00 | Y | 0.01 | Z | 0.00 |
| α | 0.00 | β | 0.00 | γ | 0.00 |

### Example 7

| | Radius of | Surface | |
|---|---|---|---|
| Surface No. | Curvature | Separation | Decentration |
| Object Plane | ∞ | | |
| 1 | ∞ | | Decentration [1] |
| 2 | FFS [1] | | Decentration [2] |
| 3 | (Stop Surface) | | Decentration [3] |
| 4 | FFS [2] | | Decentration [4] |
| 5 | ∞ | | Decentration [5] |
| Image Plane | ∞ | 0.01 | Decentration [6] |

### Example 7

| | Refractive | Abbe |
|---|---|---|
| Surface No. | Index | Constant |
| Object Plane | | |
| 1 | 1.5163 | 64.14 |
| 2 | 1.5163 | 64.14 |
| 3 | 1.5163 | 64.14 |
| 4 | 1.5163 | 64.14 |
| 5 | | |
| Image Plane | | |

FFS [1]

| | | | | | |
|---|---|---|---|---|---|
| C4 | −4.0024e−002 | C6 | −3.5143e−002 | C8 | −6.2474e−004 |
| C10 | 3.4528e−003 | C11 | 2.9303e−003 | C13 | −6.7421e−003 |
| C15 | 7.0222e−003 | C17 | 6.8209e−003 | C19 | −1.2459e−002 |
| C21 | 1.2650e−002 | C22 | −2.0604e−004 | C24 | 7.3980e−003 |
| C26 | −6.2119e−003 | C28 | 8.3719e−003 | C67 | 2.7000e+001 |

FFS [2]

| | | | | | |
|---|---|---|---|---|---|
| C4 | 4.3463e−002 | C6 | 4.4335e−002 | C8 | 9.4348e−003 |
| C10 | −4.7565e−003 | C11 | 5.0502e−003 | C13 | −3.8908e−002 |
| C15 | −1.2045e−002 | C17 | −8.4975e−003 | C19 | 7.8838e−002 |
| C21 | 3.7374e−002 | C22 | −3.4944e−002 | C24 | 1.7183e−002 |
| C26 | −5.3256e−002 | C28 | −2.3660e−002 | C67 | 2.7000e+001 |

Decentration [1]

| | | | | | |
|---|---|---|---|---|---|
| X | 0.00 | Y | 0.00 | Z | 6.69 |
| α | 5.15 | β | 0.00 | γ | 0.00 |

Decentration [2]

| | | | | | |
|---|---|---|---|---|---|
| X | 0.00 | Y | 0.43 | Z | 9.57 |
| α | 19.93 | β | 0.00 | γ | 0.00 |

Decentration [3]

| | | | | | |
|---|---|---|---|---|---|
| X | 0.00 | Y | −0.47 | Z | 8.89 |
| α | 40.00 | β | 0.00 | γ | 0.00 |

Decentration [4]

| | | | | | |
|---|---|---|---|---|---|
| X | 0.00 | Y | −1.33 | Z | 8.35 |
| α | 49.84 | β | 0.00 | γ | 0.00 |

Decentration [5]

| | | | | | |
|---|---|---|---|---|---|
| X | 0.00 | Y | 0.95 | Z | 8.77 |
| α | 60.89 | β | 0.00 | γ | 0.00 |

Decentration [6]

| | | | | | |
|---|---|---|---|---|---|
| X | 0.00 | Y | 1.73 | Z | 9.62 |
| α | 60.51 | β | 0.00 | γ | 0.00 |

### Example 8

| | Radius of | Surface | |
|---|---|---|---|
| Surface No. | Curvature | Separation | Decentration |
| Object Plane | ∞ | | |
| 1 | ∞ | 3.00 | |
| 2 | FFS [1] | −3.44 | Decentration [1] |
| 3 | FFS [2] | 3.00 | Decentration [2] |
| 4 | ∞ | 1.00 | Decentration [3] |
| 5 | (Stop Surface) | 0.50 | |
| 6 | ∞ | 2.00 | Decentration [4] |
| 7 | FFS [3] | −1.78 | Decentration [5] |
| 8 | FFS [4] | 1.45 | Decentration [6] |
| 9 | ∞ | 0.40 | Decentration [7] |
| Image Plane | ∞ | 0.00 | Decentration [8] |

### Example 8

| | Refractive | Abbe |
|---|---|---|
| Surface No. | Index | Constant |
| Object Plane | | |
| 1 | 1.5305 | 51.95 |
| 2 | 1.5305 | 51.95 |
| 3 | 1.5305 | 51.95 |
| 4 | | |
| 5 | | |
| 6 | 1.5185 | 55.78 |
| 7 | 1.5185 | 55.78 |
| 8 | 1.5185 | 55.78 |
| 9 | | |
| Image Plane | | |

FFS [1]

| | | | | | |
|---|---|---|---|---|---|
| C4 | −2.5512e−003 | C6 | −3.4132e−002 | C8 | 1.3331e−003 |
| C10 | 5.0427e−004 | C11 | 1.4395e−002 | C13 | 7.3339e−003 |
| C15 | −3.2549e−003 | C17 | −4.9237e−003 | C19 | −6.3709e−004 |
| C21 | 4.1732e−003 | C22 | −2.9003e−001 | C24 | −1.5210e−002 |
| C26 | 2.3832e−002 | C28 | 3.6031e−002 | | |

FFS [2]

| | | | | | |
|---|---|---|---|---|---|
| C4 | 3.1843e−002 | C6 | −1.8192e−002 | C8 | 5.2198e−004 |
| C10 | 2.9435e−003 | C11 | 5.3385e−003 | C13 | 9.0960e−003 |
| C15 | −7.0814e−003 | C17 | 1.3821e−004 | C19 | −2.8967e−003 |
| C21 | 1.2650e−002 | C22 | −8.5529e−002 | C24 | −1.1548e−002 |
| C26 | 3.7678e−002 | C28 | 1.7264e−001 | | |

FFS [3]

| | | | | | |
|---|---|---|---|---|---|
| C4 | −3.2118e−002 | C6 | −6.6568e−002 | C7 | 1.2228e−005 |
| C9 | −4.0267e−005 | C11 | 1.6847e−001 | C13 | 1.6048e−002 |
| C15 | 1.3442e−003 | C17 | 9.6272e−003 | C19 | −2.5565e−003 |
| C21 | 2.0287e−004 | C22 | −5.7490e+000 | C24 | −7.9876e−002 |
| C26 | 1.3410e−002 | C28 | 3.0742e−004 | | |

FFS [4]

| | | | | | |
|---|---|---|---|---|---|
| C4 | 6.6622e−002 | C6 | 2.3505e−002 | C8 | −4.7026e−002 |
| C10 | −6.6571e−003 | C11 | −7.9568e−002 | C13 | 1.4131e−001 |
| C15 | 6.7876e−003 | C17 | 1.9257e−001 | C19 | −2.0689e−001 |
| C21 | −8.1743e−004 | C22 | 3.2937e+000 | C24 | −3.7508e−001 |
| C26 | 1.6105e−001 | C28 | −8.8722e−004 | | |

Decentration [1]

| | | | | | |
|---|---|---|---|---|---|
| X | 0.00 | Y | 0.02 | Z | 0.00 |
| α | 20.99 | β | 0.00 | γ | 0.00 |

Decentration [2]

| | | | | | |
|---|---|---|---|---|---|
| X | 0.00 | Y | 0.00 | Z | 0.00 |
| α | 15.90 | β | 0.00 | γ | 0.00 |

Decentration [3]

| | | | | | |
|---|---|---|---|---|---|
| X | 0.00 | Y | 0.00 | Z | 0.00 |
| α | 0.00 | β | 0.00 | γ | 0.00 |

Decentration [4]

| | | | | | |
|---|---|---|---|---|---|
| X | 0.00 | Y | 0.00 | Z | 0.00 |
| α | 0.00 | β | 0.00 | γ | 0.00 |

Decentration [5]

| | | | | | |
|---|---|---|---|---|---|
| X | 0.00 | Y | 0.00 | Z | 0.00 |
| α | −12.10 | β | 0.00 | γ | 0.00 |

Decentration [6]

| | | | | | |
|---|---|---|---|---|---|
| X | 0.00 | Y | −0.23 | Z | 0.00 |
| α | −23.60 | β | 0.00 | γ | 0.00 |

Decentration [7]

| | | | | | |
|---|---|---|---|---|---|
| X | 0.00 | Y | 0.00 | Z | 0.00 |
| α | −0.58 | β | 0.00 | γ | 0.00 |

Decentration [8]

| | | | | | |
|---|---|---|---|---|---|
| X | 0.00 | Y | 0.20 | Z | 0.00 |
| α | −1.40 | β | 0.00 | γ | 0.00 |

### Example 9

| | Radius of | Surface | |
|---|---|---|---|
| Surface No. | Curvature | Separation | Decentration |
| Object Plane | ∞ | | |
| 1 | ∞ | 4.94 | |
| 2 | FFS [1] | −3.61 | Decentration [1] |
| 3 | FFS [2] | 5.98 | Decentration [2] |
| 4 | ∞ | 3.35 | |
| 5 | (Stop Surface) | 2.28 | Decentration [3] |
| 6 | ∞ | 6.63 | |
| 7 | FFS [3] | −6.50 | Decentration [4] |
| 8 | FFS [4] | 7.72 | Decentration [5] |
| 9 | ∞ | 13.70 | |
| 10 | 0.25 | 0.50 | |
| Image Plane | ∞ | | |

### Example 9

| | Refractive | Abbe |
|---|---|---|
| Surface No. | Index | Constant |
| Object Plane | | |
| 1 | 1.5254 | 56.00 |
| 2 | 1.5254 | 56.00 |
| 3 | 1.5254 | 56.00 |
| 4 | | |
| 5 | | |
| 6 | 1.5254 | 56.00 |
| 7 | 1.5254 | 56.00 |
| 8 | 1.5254 | 56.00 |
| 9 | | |
| 10 | 1.5163 | 64.14 |
| Image Plane | | |

FFS [1]

| | | | | | |
|---|---|---|---|---|---|
| C4 | −2.6476e−002 | C6 | −2.3209e−002 | C8 | −2.8863e−004 |
| C10 | −1.6773e−003 | C11 | −1.0267e−005 | C13 | 2.2307e−006 |
| C15 | 2.9969e−004 | C17 | −1.4732e−006 | C19 | −1.2827e−005 |
| C21 | −3.0616e−005 | C22 | −6.1866e−007 | C24 | 5.7059e−007 |
| C26 | 7.4038e−007 | C28 | 4.5920e−006 | C67 | 2.7000e+001 |

FFS [2]

| | | | | | |
|---|---|---|---|---|---|
| C4 | 2.3718e−002 | C6 | 1.9921e−002 | C8 | 5.3007e−004 |
| C10 | −9.8515e−004 | C11 | −1.0203e−004 | C13 | −1.6529e−004 |
| C15 | 9.8268e−005 | C17 | −5.5424e−006 | C19 | −2.3796e−005 |
| C21 | −8.9199e−006 | C67 | 2.0000e+001 | | |

FFS [3]

| | | | | | |
|---|---|---|---|---|---|
| C4 | −1.5948e−002 | C6 | −1.5580e−002 | C8 | −3.9738e−004 |
| C10 | −1.7819e−003 | C11 | 5.0737e−005 | C13 | 2.2106e−004 |
| C15 | 1.9040e−004 | C17 | 8.2287e−007 | C19 | −1.1215e−005 |
| C21 | −2.0246e−005 | C67 | 2.0000e+001 | | |

FFS [4]

| | | | | | |
|---|---|---|---|---|---|
| C4 | 1.7476e−002 | C6 | 1.3089e−002 | C8 | 3.2025e−005 |
| C10 | −1.0668e−003 | C11 | 1.5877e−005 | C13 | 1.2046e−004 |
| C15 | 9.6401e−005 | C67 | 1.4000e+001 | | |

Decentration [1]

| | | | | | |
|---|---|---|---|---|---|
| X | 0.00 | Y | −0.07 | Z | 0.00 |
| α | 19.63 | β | 0.00 | γ | 0.00 |

Decentration [2]

| | | | | | |
|---|---|---|---|---|---|
| X | 0.00 | Y | 0.12 | Z | −0.70 |
| α | 25.13 | β | 0.00 | γ | 0.00 |

Decentration [3]

| | | | | | |
|---|---|---|---|---|---|
| X | 0.00 | Y | −0.08 | Z | 0.00 |
| α | 0.00 | β | 0.00 | γ | 0.00 |

Decentration [4]

| | | | | | |
|---|---|---|---|---|---|
| X | 0.00 | Y | 0.00 | Z | 0.00 |
| α | 25.13 | β | 0.00 | γ | 0.00 |

Decentration [5]

| | | | | | |
|---|---|---|---|---|---|
| X | 0.00 | Y | −0.00 | Z | 0.00 |
| α | 19.63 | β | 0.00 | γ | 0.00 |

| | | |
|---|---|---|
| Object side | NA | 0.1 |
| Image side | NA | 0.18 |

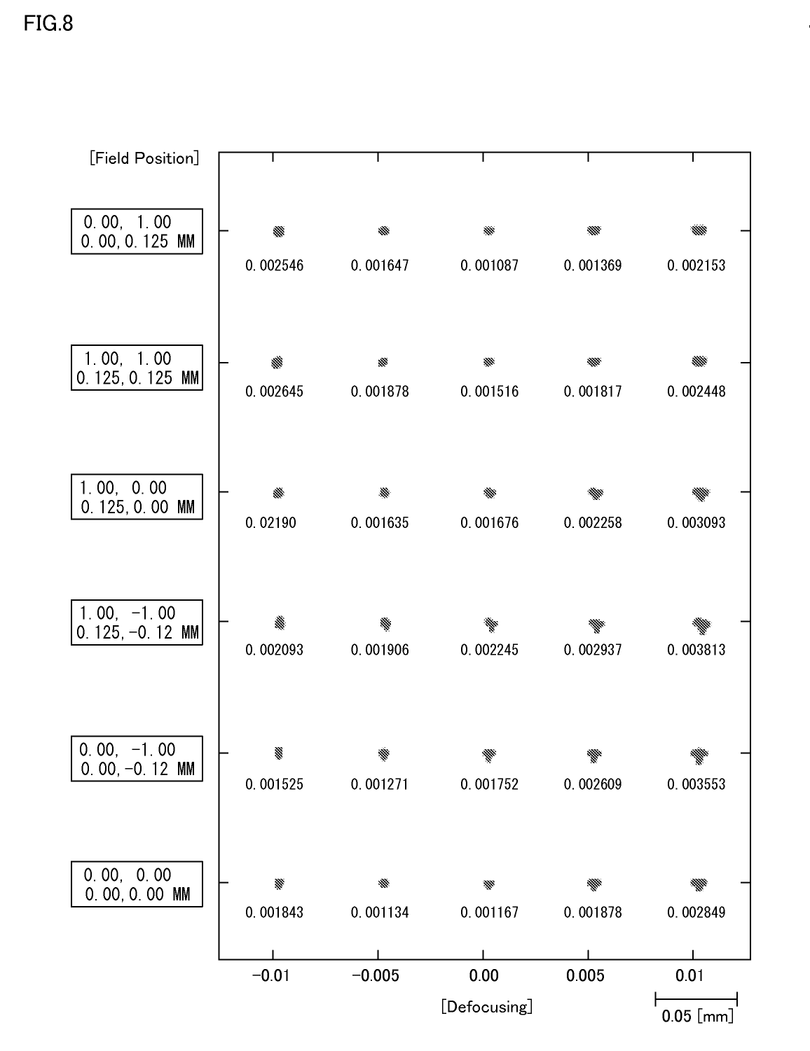

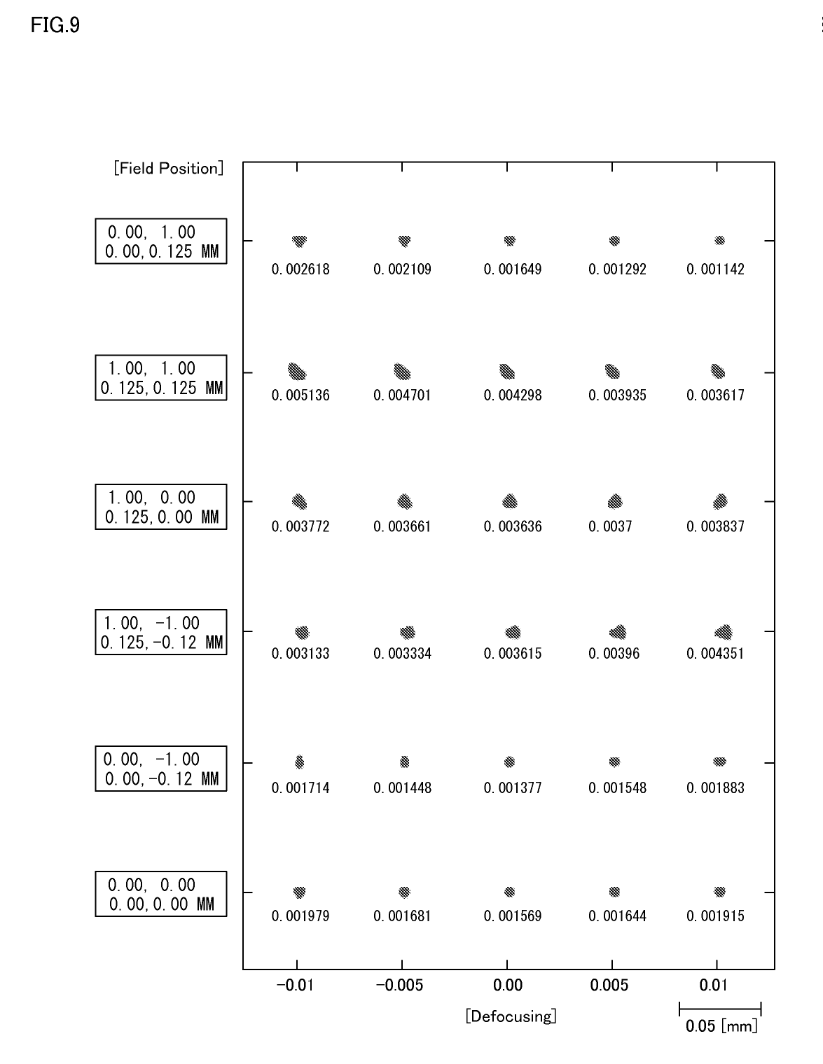

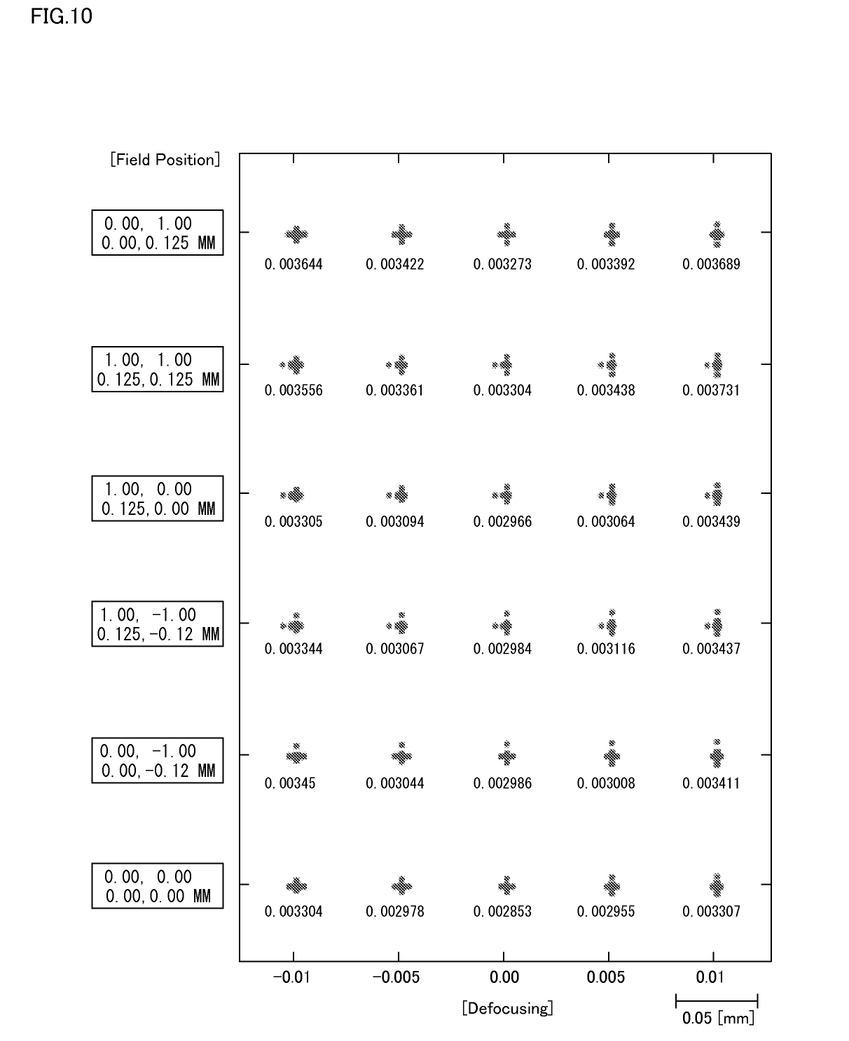

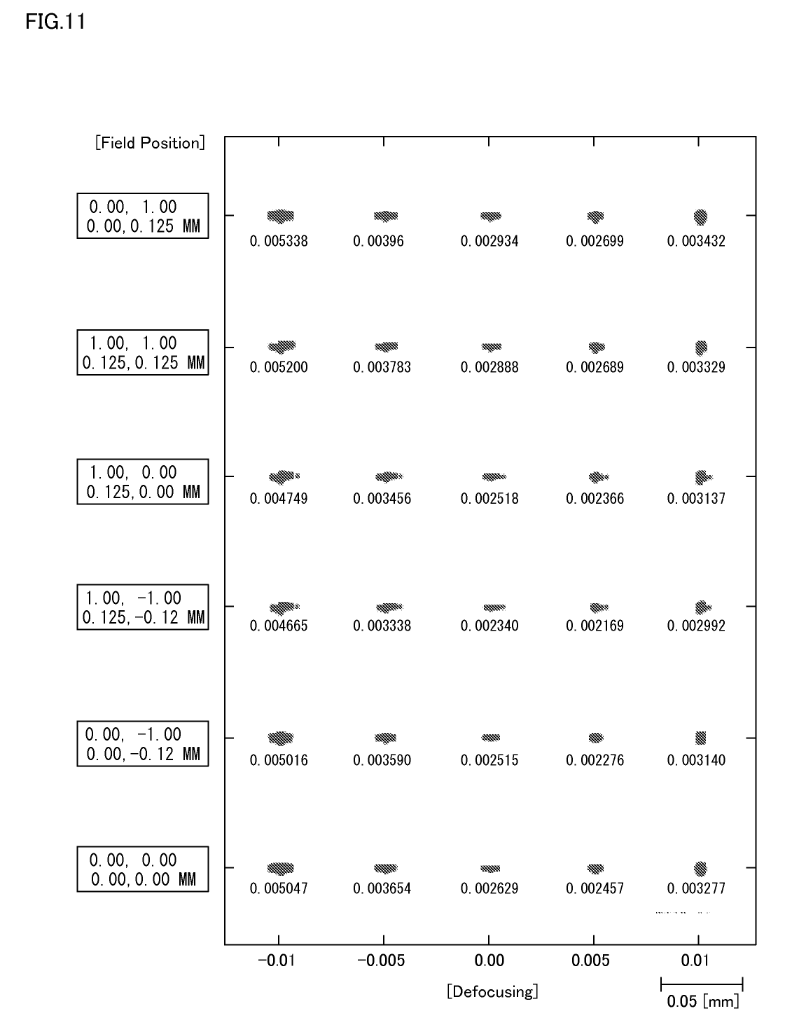

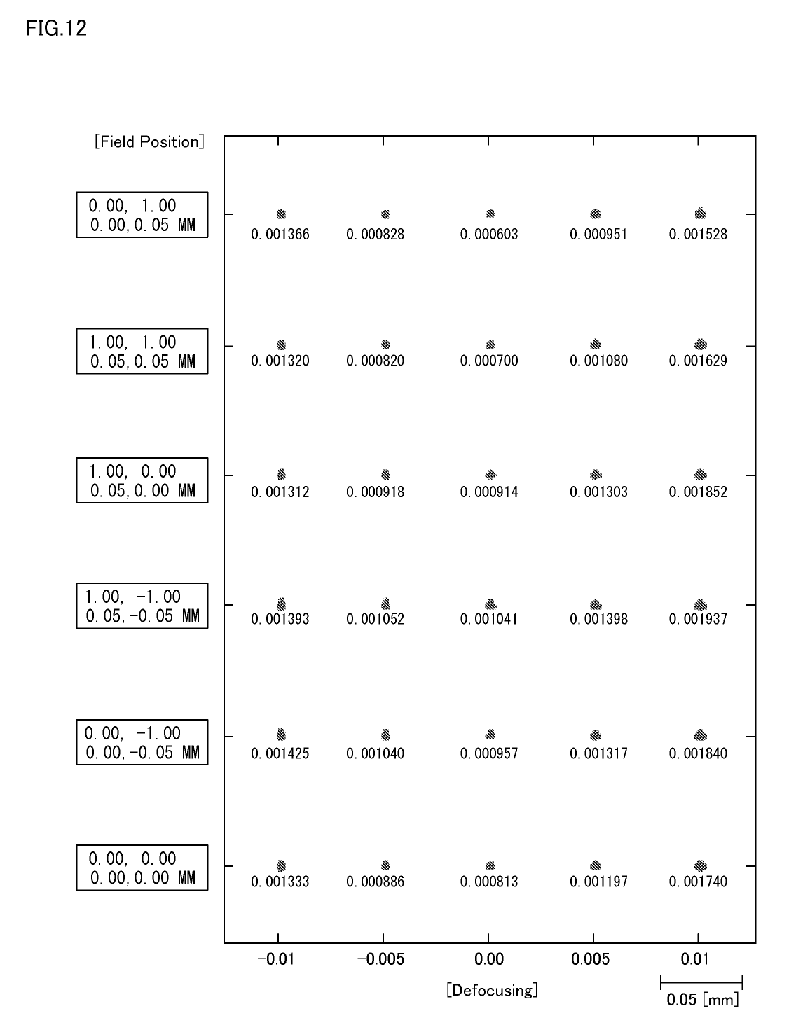

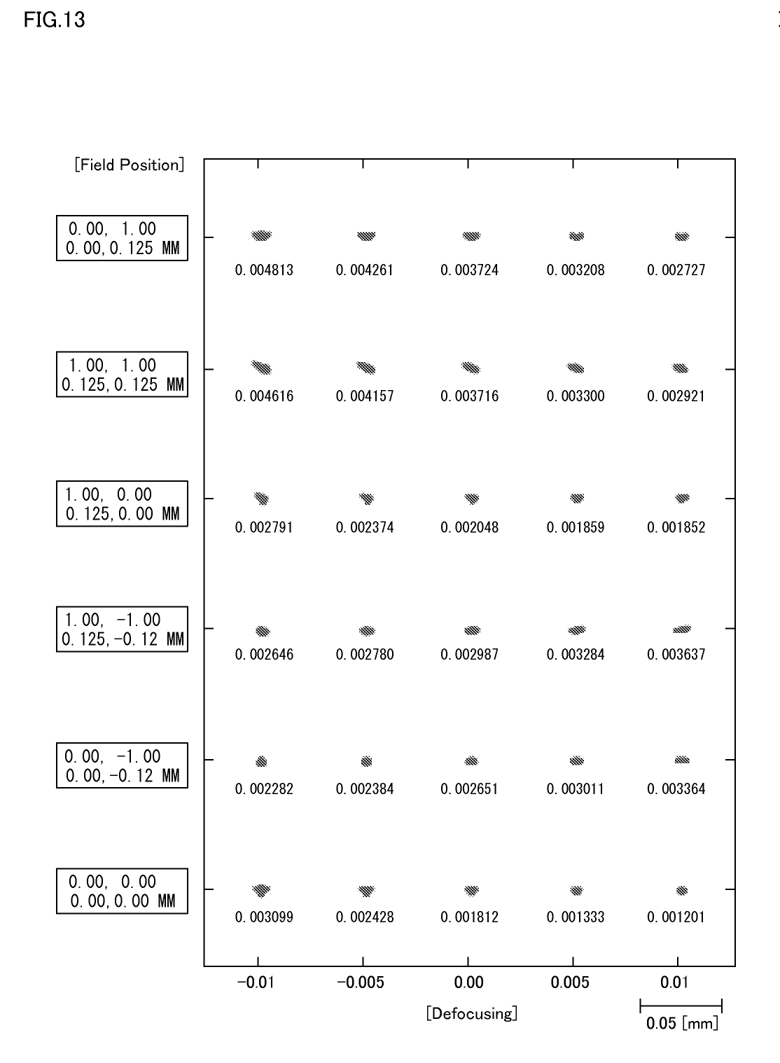

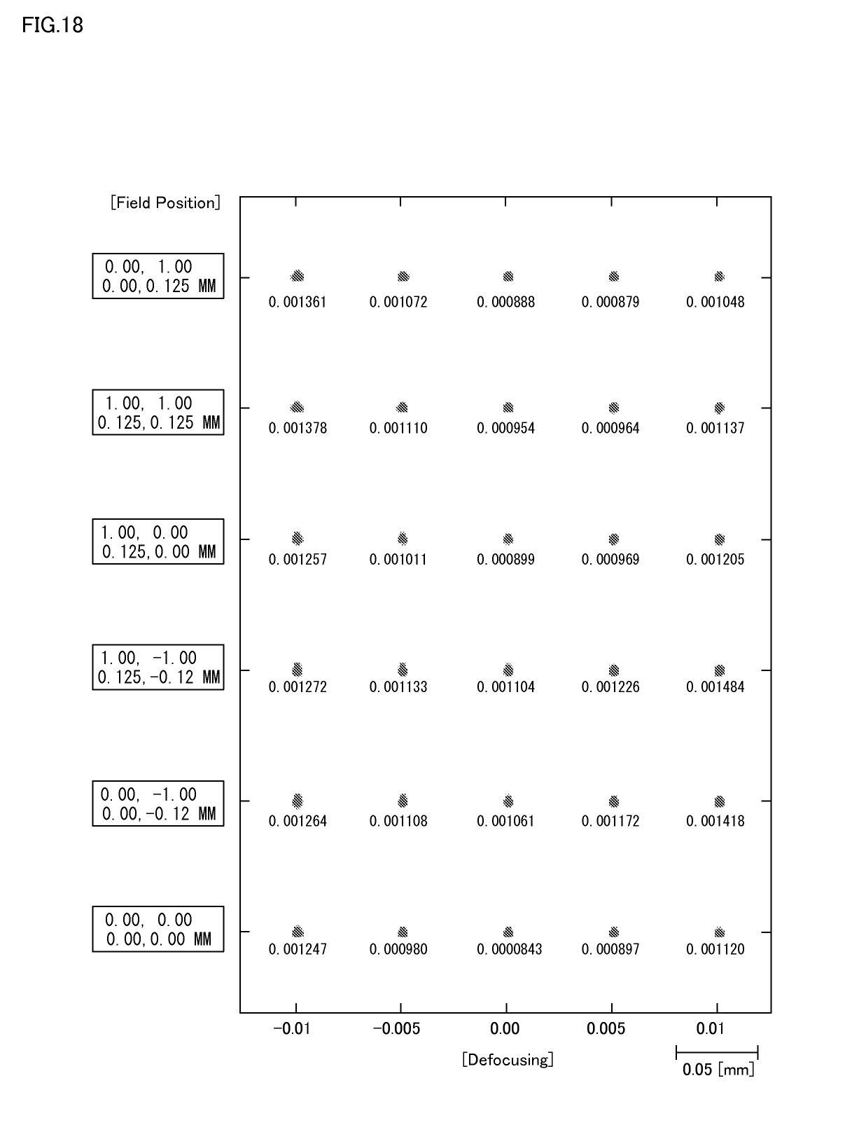

FIGS. 8 to 13 are indicative of spot diagrams for the second optical elements in Examples 1 to 6, and FIGS. 18 to 13 are indicative of spot diagrams for the second optical elements in Examples 7 and 8 for each wavelength (1600 nm, 1550 nm, 1500 nm), with the first optical element position as ordinate (Field Position) and the amount of defocusing of the surface measured (second optical element) as abscissa. Note here that the numerical values given below the respective spot diagrams are indicative of light ray variations (RMS).

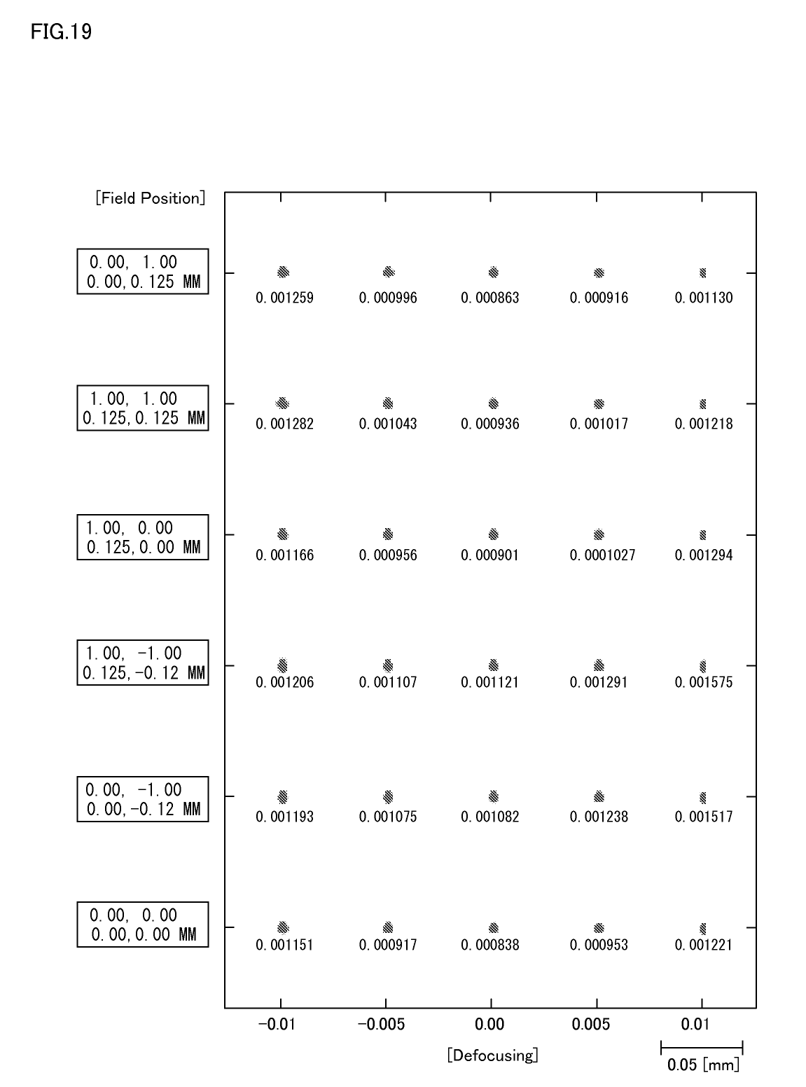

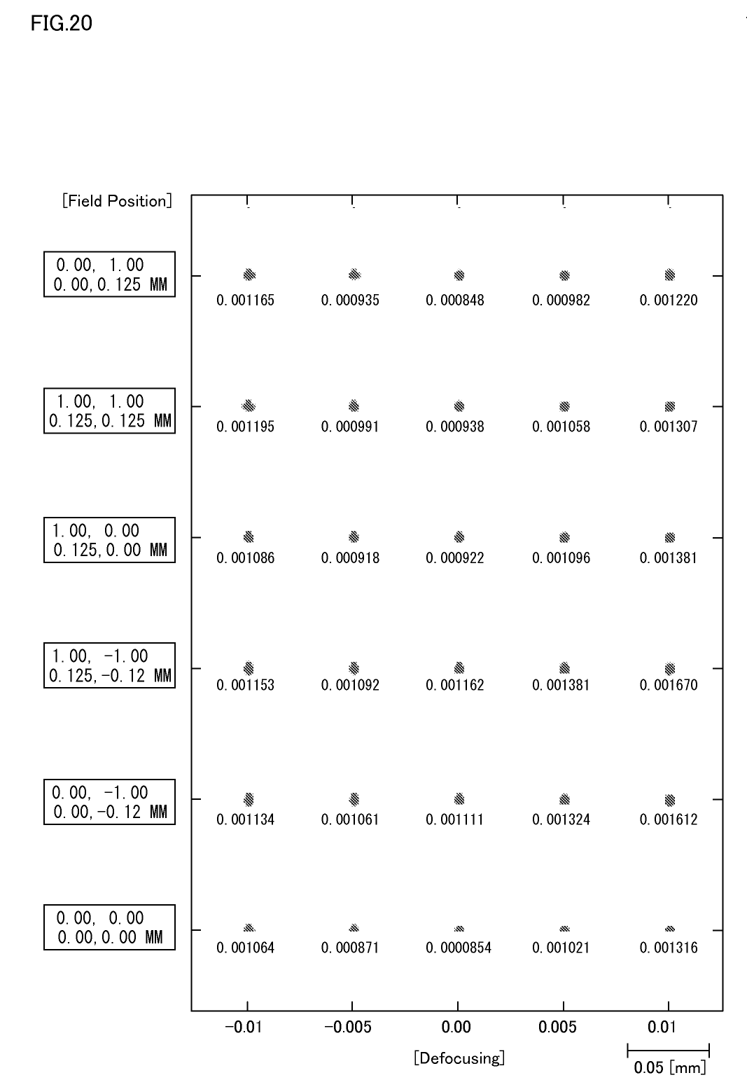

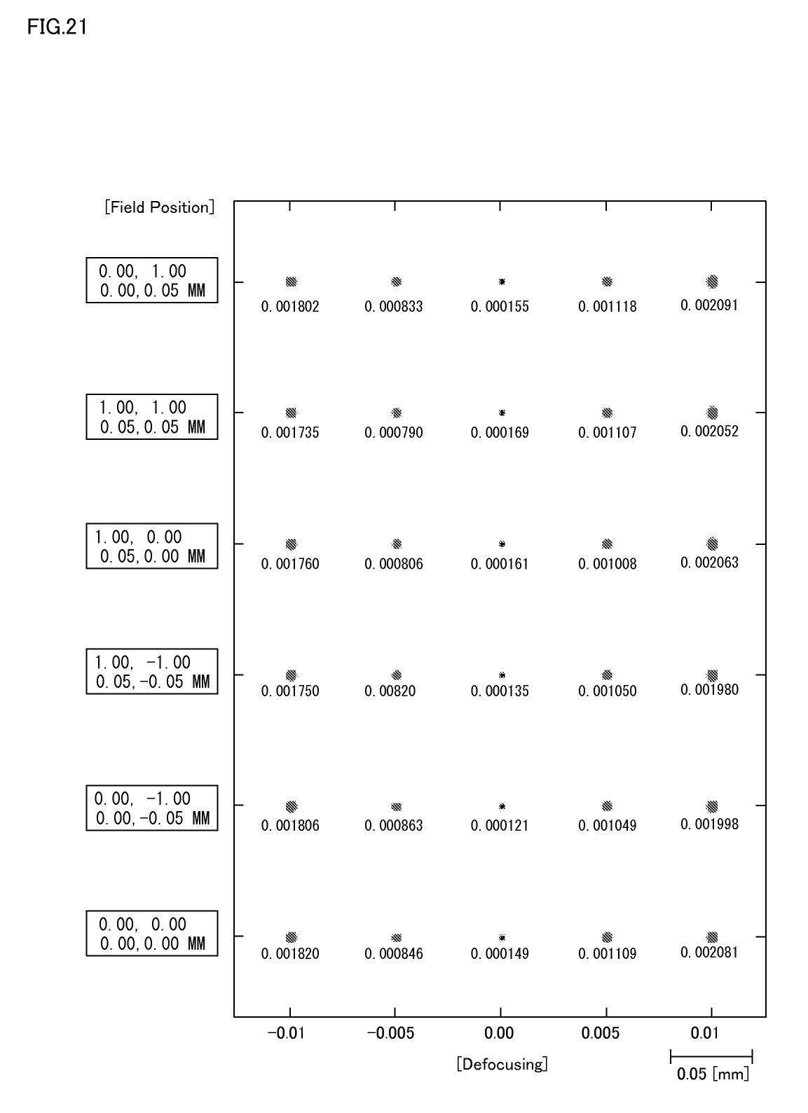

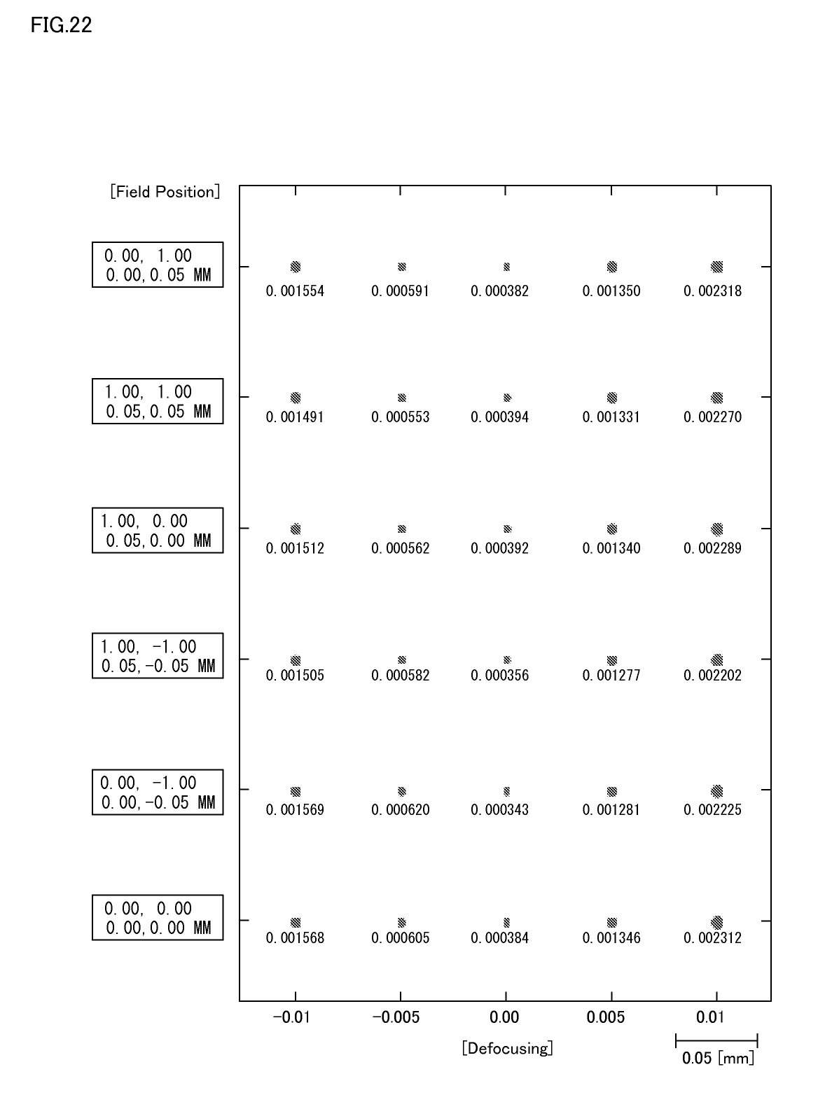

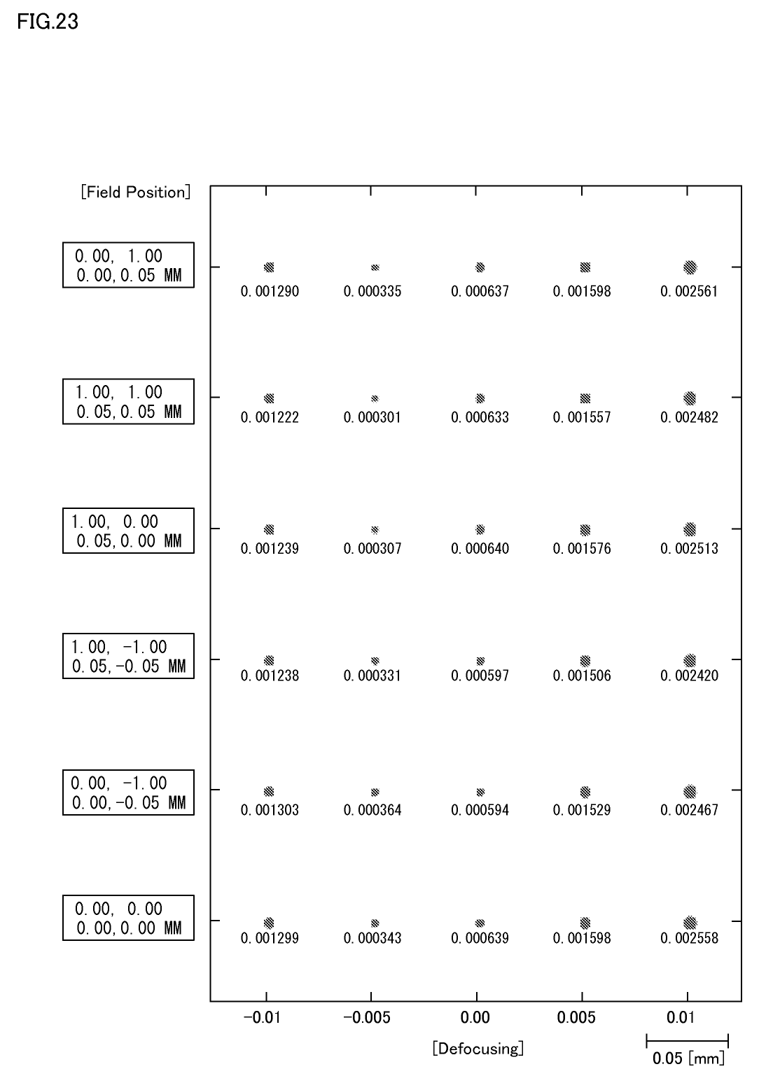

In the optical systems of Examples 1 to 6 there is no chromatic aberration occurring from each optical system because the optical element having optical functions is only the surface reflecting mirror. While any particular wavelength is not specified because there is no wavelength-depending change in the spot diagrams indicative of the imaging capability of each optical system, it is to be appreciated that in Examples 7 to 9, there are wavelength-depending changes found in the imaging capability because chromatic aberration is produced while light beams pass through the transparent medium having a reflectance of at least 1. FIGS. 18 to 23 are indicative of spot diagrams for Examples 7 and 8 at three wavelengths: 1600 nm, 1550 nm and 1500 nm. From these figures it is found that in Examples 7 and 8 there are less than 1 μm changes in the size of the spot diagrams in a wavelength region of 100 nm: the wavelength-depending capability changes are restrictive.

Set out in Table 4 are the values of the aforesaid conditions (1) and (2) in the respective examples.

TABLE 4
Values of TAX [degrees]

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| F2 | 2.85 | 0.006 | 0.09 | 1.17 | 0.25 | 0.61 | 0.73 | 0.006 | 2.03 |
| F3 | 4.04 | 0.037 | 0.69 | 1.66 | 0.25 | 0.92 | 1.03 | 0.996 | 2.98 |
| F4 | 2.86 | 0.052 | 0.69 | 1.18 | 0 | 1.15 | 0.73 | 0.989 | 2.11 |
| F5 | 4.02 | 0.105 | 0.69 | 1.67 | 0.25 | 2.56 | 1.03 | 0.996 | 2.98 |
| F6 | 2.83 | 0.009 | 0.8 | 1.19 | 0.25 | 1.95 | 0.73 | 0.034 | 2.05 |

Set out in Table 5 are the values of the aforesaid conditions (3) and (4) in the respective examples.

TABLE 5
Values of TAN [degrees]

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| F2 | 0 | 0.52 | 0 | 0 | 0 | 1.79 | 0.75 | 0 | 0 |
| F3 | 0 | 0.61 | 0 | 0 | 0 | 2.53 | 1.05 | 0 | 0 |
| F4 | 0 | 0.13 | 0 | 0 | 0 | 1.79 | 0.71 | 0 | 0 |
| F5 | 0 | 0.27 | 0 | 0 | 0 | 2.53 | 0.98 | 0 | 0 |
| F6 | 0 | 0.51 | 0 | 0 | 0 | 1.79 | 0.66 | 0 | 0 |

Set out in Table 6 are the values of the aforesaid conditions (5) and (6) in the respective examples.

TABLE 6

| | AOI | ABM |
|---|---|---|
| Ex. 1 | 15.46 | 26.96 |
| Ex. 2 | 13.01 | 0 |
| Ex. 3 | 20.73 | 34.27 |
| Ex. 4 | 22.21 | 46.31 |
| Ex. 5 | 19.99 | 45 |
| Ex. 6 | 14.71 | 0 |
| Ex. 7 | 16.69 | 20.06 |
| Ex. 8 | 20.9 | 36.89 |
| Ex. 9 | 19.83 | 44.76 |

While the present invention has been explained with reference to various embodiments, it is to be appreciated that the present invention is not limited to these embodiments alone, so modifications or variations comprising appropriate combinations thereof are to be encompassed within the category of the invention too.

### EXPLANATIONS OF THE NUMERAL REFERENCES

1: Coupling optical system
11: First reflecting surface
12: Second reflecting surface
13: Third reflecting surface
14: Fourth reflecting surface
2: First optical element
3: Second optical element
10: First decentered prism
20: Second decentered prism
40: Microlens array (adjustment optical element)
41: Entrance surface
41a-41c: Unit surfaces
1A: Optical unit
S: Aperture stop position
T: Intermediate image position
2: First optical element
2a-2c: Single core fibers
3: Second optical element (multicore fiber)

What is claimed is:

1. A coupling optical system for entering a light beam emitted out of a first optical element into a second optical element, characterized by including at least two reflecting surfaces, wherein:
at least one said reflecting surface has a rotationally asymmetric surface shape, and at least two said reflecting surfaces are each decentered with respect to an axial principal ray connecting a center of said first optical element with a center of said second optical element.

2. The coupling optical system of claim 1, wherein:
said first optical element emits out multiple light beams, and
said coupling optical system converges said multiple light beams emitted out of said first optical element collectively into converged light for incidence on said second optical element.

3. The coupling optical system of claim 1, which satisfies the following condition (1):
TAN≦5° (1)
where TAN is a difference between angles of incidence of principal rays of an off-axis light beam and an axial light beam incident on said second optical element.

4. The coupling optical system of claim 1, which satisfies the following condition (2):
TAN≦3 ° (2)
where TAN is a difference between angles of incidence of principal rays of an off-axis light beam and an axial light beam incident on said second optical element.

5. The coupling optical system of claim 1, which satisfies the following condition (3):
TAX≦5° (3)
where TAX is a difference between angles of exit of a principal ray and an axial principal ray of an off-axis light beam emitted out of said first optical element.

6. The coupling optical system of claim 1, which satisfies the following condition (4):
TAX≦3° (4)
where TAX is a difference between angles of exit of a principal ray and an axial principal ray of an off-axis light beam emitted out of said first optical element.

7. The coupling optical system of claim 1, wherein said at least two reflecting surfaces are reflecting mirrors.

8. The coupling optical system of claim 1, which includes at least four reflecting surfaces.

9. The coupling optical system of claim 8, wherein said at least four reflecting surfaces are reflecting mirrors.

10. The coupling optical system of claim 1, which includes between at least two of said reflecting surfaces a decentered prism filled with a medium having a reflectance of at least 1.

11. The coupling optical system of claim 10, which includes at least two said decentered prisms.

12. The coupling optical system of claim 1, which includes at least four said reflecting surfaces, wherein an aperture stop position of said coupling optical system is located between a second reflecting surface and a third reflecting surface provided that there are a first reflecting surface, said second reflecting surface, said third reflecting surface and a fourth reflecting surface as counted in order from said first optical element side.

13. The coupling optical system of claim 1, which includes at least four said reflecting surfaces, wherein an intermediate image is formed between a second reflecting surface and a third reflecting surface of at least four said reflecting surfaces provided that there are a first reflecting surface, said second reflecting surface, said third reflecting surface and a fourth reflecting surface as counted in order from said first optical element side.

14. The coupling optical system of claim 1, which is telecentric on at least one of said first optical element side and said second optical element side.

15. The coupling optical system of claim 1, which is non-telecentric on said first optical element side and telecentric on said second optical element side.

16. The coupling optical system of claim 1, which is telecentric on both said first optical element side and said second optical element side.

17. The coupling optical system of claim 1, wherein an aperture stop position of said coupling optical system is located between a first reflecting surface and a second reflecting surface provided that there are said first reflecting surface and said second reflecting surface as counted in order from said first optical element side.

18. The coupling optical system of claim 1, wherein at least two said reflecting surfaces have each a positive power.

19. The coupling optical system of claim 1, which satisfies the following condition (5):
AOI≦45° (5)
where AOI is an angle of incidence of a first reflecting surface provided that there are said first reflecting surface and a second reflecting surface as counted in order from said first optical element side.

20. The coupling optical system of claim 1, which includes a first reflecting surface and a second reflecting surface as counted in order from said first optical element side, and wherein, when a Z-axis positive direction is defined by a direction propagating along an axial principal ray with said first optical element as an origin, a Y-Z plane is defined by a plane including said Z-axis and a center of said first reflecting surface, an X-axis positive direction is defined by a direction passing through the origin and orthogonal to said Y-Z plane, and a Y-axis is defined by an axis that forms with said X-axis and said Z-axis a right-handed orthogonal coordinate system, said first reflecting surface and said second reflecting surface include a quantity of decentration in the same plane, and said coupling optical system satisfies the following condition (6):
−30°≦ABM≦60° (6)
where ABM is an angle made between said first reflecting surface and said second reflecting surface in the Y-Z plane.

21. The coupling optical system of claim 1, wherein either one of said first optical element and said second optical element is an optical fiber.

22. The coupling optical system of claim 1, wherein said at least two reflecting surfaces are integrated together at back sides thereof.

23. The coupling optical system of claim 1, which includes an adjustment optical element capable of adjusting a numerical aperture, wherein said adjustment optical element is positioned in the vicinity of at least one of said first optical element and said second optical element or in contact with said first optical element and said second optical element for incidence of a light beam emitted out of said first optical element on said second optical element.

24. The coupling optical system of claim 23, wherein said adjustment optical element has a positive or negative power.

25. The coupling optical system of claim 24, wherein said adjustment optical element is a micro-lens array.
